(19) United States
(12) Patent Application Publication
(10) Pub. No.: US 2007/0193809 A1
(43) Pub. Date: Aug. 23, 2007

(54) 4 Wheel Drive of Hydraulic Manual and Automatic Transmission

(76) Inventors: Gyung Jin Song, Jeollabuk-do (KR); Young Sick Song, Seoul (KR); Won Chan Song, Seoul (KR); Won Gi Song, Seoul (KR); Jerng Sik Song, Seoul (KR); Jung Sik Song, Seoul (KR); Heon Chae, Seoul (KR); In Chung Song, Seoul (KR); Je Wan Chae, Seoul (KR)

Correspondence Address: OSHA LIANG L.L.P., 1221 MCKINNEY STREET, SUITE 2800, HOUSTON, TX, 77010, US

(21) Appl. No.: 11/597,310

(22) PCT Filed: May 24, 2005
(86) PCT No.: PCT/KR05/01515

§ 371 Date: Nov. 22, 2006

(30) Foreign Application Priority Data
May 24, 2004 (KR) 10-2004-0036998

(51) Int. Cl. B60K 23/08

(52) U.S. Cl. 180/247

(57) ABSTRACT

Disclosed is a 4-wheel drive of hydraulic manual and automatic transmission of a vehicle running on a road by transmitting rotational engine force to rear wheels, which allows manual or automatic gear shifting using hydraulic rotary machines rotating a main shaft by hydraulic pressure and hydraulic rotary machines independently installed to each wheel and allows to drive 4-wheels including front wheels whitout use of a differential gear. A transmission control panel that is installed to a center portion of a steering wheel and acts as a manual and automatictransmission causing instant gear shifting without a differential gear or a clutch by manipulating a transmission level and a transmission switch in a convenient and easy way. A switch device having many switches concentrated on the fixed center portion of a steering wheel to allow a user to rapidly turn on or off the switch buttons during stopping or running.

### TECHNICAL FIELD

The present invention relates to a 4 wheel drive of hydraulic manual and automatic transmission of a vehicle running on a road by transmitting rotational force of an engine to rear wheels, which allows manual or automatic gear shifting using a hydraulic rotary machine rotating a main shaft by hydraulic pressure and a hydraulic rotary machine independently installed to each wheel and allows to drive 4 wheels including front wheels without use of a differential gear.

The present invention also relates to a transmission control panel that is installed to a center portion of a steering wheel and acts as a manual and automatic transmission causing instant gear shifting without a differential gear or a clutch by manipulating a transmission lever and a transmission switch in a convenient and easy way.

In addition, the present invention relates to a switch device having many switches concentrated on the fixed center portion of a steering wheel to allow a user to rapidly turn on or off the switch buttons during stopping or running.

### BACKGROUND ART

A transmission used in the conventional vehicle changes arrangement of gear rows according to a running speed of the vehicle to shift gears. This transmission may be classified into a manual type and an automatic type according to the fact that such shift of gear row is performed manually or automatically using hydraulic pressure.

The manual transmission is inconvenient since gears should be shifted by manually manipulating a transmission lever to give a rotational number suitable for the speed of the vehicle, ensures reliable gear shifting and thus a good fuel consumption ratio. The automatic transmission has no inconvenience to shift gears according to the speed of vehicle, but its complex configuration causes high price and frequent malfunctions.

### DISCLOSURE OF INVENTION

Technical Problem

The present invention is directed to transmitting a rotational force of an engine to wheels via a main shaft, wherein a hydraulic rotary machine is provided in multi layers to the main shaft so that a rotary pump driven by the rotational force of the engine may automatically select to introduce a liquid pressed by the pump into the multi-layer hydraulic rotary machine, thereby enabling automatic change of the rotational force of the engine and thus shifting the rotational speed of the main shaft.

Technical Solution

In order to accomplish the above object, the present invention provides a 4-wheel drive, which includes a rotary pump receiving rotating power of an engine and discharging a pressed liquid, wherein a plurality of hydraulic rotary machines are installed to a main shaft in parallel so that the hydraulic rotary machines may rotate the main shaft when the pressed liquid is supplied, wherein a pipe is connected to the hydraulic rotary machines to supply and recover the pressed liquid, wherein liquid selection valves are installed to the pipe to select flow of liquid introduced from the rotary pump to the hydraulic rotary machines or recovered from the hydraulic rotary machines to the rotary pump, wherein an electronic control device is provided to sense hydraulic pressure in the pipe and manual manipulation of a transmission lever so as to open or close the selection valves.

In addition, in the present invention, a transmission control panel is installed to a fixed center portion of a steering wheel so that an electronic control device may instantly recognize manipulation of the transmission lever and the transmission switches to ensure rapid transmission.

In addition, in the present invention, many switches are concentrated on the fixed center portion of the steering wheel so that a user may manipulate the switches in a convenient and easy way during rapid running.

In addition, the present invention provides a steering device in which the steering wheel may rotate freely though its center portion is fixed.

That is to say, in the present invention, the hydraulic rotary machines are installed to the main shaft in multi stages so that a rotational speed of the main shaft may change according to operation of the hydraulic rotary machines, wherein the hydraulic rotary machines are operated by means of supply of the liquid pressed by the rotary pump, wherein movement of liquid introduced from the rotary pump to the hydraulic rotary machines are controlled by the liquid selection valves controlled by the electronic control device to shift gears.

In addition, in the present invention, the transmission control panel is installed to the fixed center portion of the steering wheel and connected to the electronic control device to ensure convenient and rapid transmission, and many switches are concentrated on the center portion of the steering wheel so that a user may easily and rapidly turn on or off the switches even in rapid running at night.

### BRIEF DESCRIPTION OF THE DRAWINGS

FIG. 1 is a schematic diagram illustrating a 4-wheel drive according to the present invention in an idle state;

FIG. 2 is a schematic diagram illustrating a 4-wheel drive according to the present invention, shifted to a first forward stage;

FIG. 3 is a schematic diagram illustrating a 4-wheel drive according to the present invention, shifted to a first reverse stage;

FIG. 4 is a schematic diagram illustrating a 4-wheel drive according to the present invention, shifted to a second forward stage;

FIG. 5 is a schematic diagram illustrating a 4-wheel drive according to the present invention, shifted to a third forward stage;

FIG. 6 is a schematic diagram illustrating a 4-wheel drive according to the present invention, shifted to a fourth forward stage;

FIG. 7 is a schematic diagram illustrating a 4-wheel drive according to the present invention, shifted to a fifth forward stage;

FIG. 8 is a schematic diagram illustrating operation of a brake during running in a neutral state;

FIG. 9 is a schematic diagram illustrating a 4-wheel drive according to the present invention, in an idle state during rearward running;

FIG. 10 is a schematic diagram illustrating a 4-wheel drive according to the present invention when an engine stops for stoppage or parking;

FIG. 11 is a schematic diagram illustrating operation of a transmission control hydraulic pressure gauge according to the present invention;

FIG. 12 is a schematic diagram illustrating the principle of a rotary pump and a hydraulic rotary machine according to the present invention;

FIG. 13 is a schematic diagram illustrating the operating state of the rotary pump and the hydraulic rotary machine according to the present invention;

FIG. 14 is a schematic diagram illustrating the operating state of the rotary pump according to the present invention;

FIG. 15 is a schematic diagram illustrating the operating state of the hydraulic rotary machine according to the present invention;

FIGS. 16, 17 and 18 are schematic diagrams illustrating a driving shaft and a power transmission state according to an embodiment of the present invention;

FIG. 19 is a schematic diagram showing a transmission lever according to the present invention;

FIG. 20 is a schematic diagram illustrating the operation of the brake during running, in a neutral state;

FIG. 21 is a schematic diagram illustrating the operating state of a selection valve during parking when the engine stops in the present invention;

FIG. 22 is a schematic diagram illustrating a 4-wheel drive according to the present invention in a neutral state;

FIG. 23 is a schematic diagram showing a 4-wheel drive when a rearward running selection valve of the present invention;

FIG. 24 is a schematic diagram illustrating a 4-wheel drive in a neutral state during running;

FIG. 25 is a schematic diagram illustrating a 4-wheel drive according to the present invention in a high-stage shifting neutral state during running;

FIG. 26 is a side and plane view showing a transmission control panel whose transmission lever is in a neutral position according to the present invention;

FIG. 27 is a side and plane view showing a transmission control panel whose transmission lever is in a rearward transmission position according to the present invention;

FIG. 28 is a side and plane view showing a transmission control panel whose transmission lever is in a first-stage transmission position according to the present invention;

FIG. 29 is a side and plane view showing a transmission control panel whose transmission lever is in a second-stage transmission position according to the present invention;

FIG. 30 is a side and plane view showing a transmission control panel whose transmission lever is in a third-stage transmission position according to the present invention;

FIG. 31 is a side and plane view showing a transmission control panel whose transmission lever is in a fourth-stage transmission position according to the present invention;

FIG. 32 is a side and plane view showing a transmission control panel whose transmission lever is in a fifth-stage transmission position according to the present invention;

FIG. 33 is a side and plane view showing a transmission control panel whose transmission lever is in a high-stage transmission position according to the present invention, in a neutral state;

FIG. 34 is a schematic view showing a 4-wheel drive according to another embodiment of the present invention in an idle state;

FIG. 35 is a schematic view showing a 4-wheel drive according to another embodiment of the present invention in a first forward stage;

FIG. 36 is a schematic view showing a 4-wheel drive according to another embodiment of the present invention in a first rearward stage;

FIG. 37 is a schematic view showing a 4-wheel drive according to another embodiment of the present invention in a second forward stage;

FIG. 38 is a schematic view showing a 4-wheel drive according to another embodiment of the present invention in a third forward stage;

FIG. 39 is a schematic view showing a 4-wheel drive according to another embodiment of the present invention in a fourth forward stage;

FIG. 40 is a schematic view showing a 4-wheel drive according to another embodiment of the present invention in a fifth forward stage;

FIG. 41 is a schematic view showing a 4-wheel drive according to another embodiment of the present invention in a sixth forward stage;

FIG. 42 is a schematic view showing a 4-wheel drive according to another embodiment of the present invention in a seventh forward stage;

FIG. 43 is a schematic view showing a 4-wheel drive according to another embodiment of the present invention in a eighth forward stage;

FIG. 44 is a schematic view showing a 4-wheel drive according to another embodiment of the present invention in a ninth forward stage;

FIG. 45 is a schematic view showing a 4-wheel drive according to another embodiment of the present invention in a tenth forward stage;

FIG. 46 is a schematic view showing a 4-wheel drive according to another embodiment of the present invention in a eleventh forward stage;

FIG. 47 is a schematic view showing a 4-wheel drive according to another embodiment of the present invention in a twelfth forward stage;

FIG. 48 is a schematic view showing a 4-wheel drive according to another embodiment of the present invention in a thirteenth forward stage;

FIG. 49 is a schematic view showing a 4-wheel drive according to another embodiment of the present invention in a fourteenth forward stage;

FIG. 50 is a schematic view showing a 4-wheel drive according to another embodiment of the present invention in a fifteenth forward stage;

FIG. 51 is a schematic view showing a 4-wheel drive according to another embodiment of the present invention when a brake is in operation during running (in a neutral state);

FIG. 52 is a schematic view showing a 4-wheel drive according to another embodiment of the present invention in an idle state during rearward running;

FIG. 53 is a schematic view showing a 4-wheel drive according to another embodiment of the present invention when an engine stops for stoppage or parking;

FIG. 54 is a schematic view showing a 4-wheel drive according to another embodiment of the present invention in a neutral state;

FIG. 55 is a schematic view showing a 4-wheel drive according to another embodiment of the present invention when a rearward running selection button is selected;

FIG. 56 is a schematic view showing a 4-wheel drive according to another embodiment of the present invention in a neutral state during running;

FIG. 57 is a schematic view showing a 4-wheel drive according to another embodiment of the present invention in a high-stage transmission neutral state during running;

FIG. 58 is a side and plane view showing a transmission control panel whose transmission lever is in a neutral position according to the present invention;

FIG. 59 is a side and plane view showing a transmission control panel whose transmission lever is in a rearward transmission position according to the present invention;

FIG. 60 is a side and plane view showing a transmission control panel whose transmission lever is in a first-stage transmission position according to the present invention;

FIG. 61 is a side and plane view showing a transmission control panel whose transmission lever is in a second-stage transmission position according to the present invention;

FIG. 62 is a side and plane view showing a transmission control panel whose transmission lever is in a third-stage transmission position according to the present invention;

FIG. 63 is a side and plane view showing a transmission control panel whose transmission lever is in a fourth-stage transmission position according to the present invention;

FIG. 64 is a side and plane view showing a transmission control panel whose transmission lever is in a fifth-stage transmission position according to the present invention;

FIG. 65 is a side and plane view showing a transmission control panel whose transmission lever is in a sixth-stage transmission position according to the present invention;

FIG. 66 is a side and plane view showing a transmission control panel whose transmission lever is in a seventh-stage transmission position according to the present invention;

FIG. 67 is a side and plane view showing a transmission control panel whose transmission lever is in a eighth-stage transmission position according to the present invention;

FIG. 68 is a side and plane view showing a transmission control panel whose transmission lever is in a ninth-stage transmission position according to the present invention;

FIG. 69 is a side and plane view showing a transmission control panel whose transmission lever is in a tenth-stage transmission position according to the present invention;

FIG. 70 is a side and plane view showing a transmission control panel whose transmission lever is in a eleventh-stage transmission position according to the present invention;

FIG. 71 is a side and plane view showing a transmission control panel whose transmission lever is in a twelfth-stage transmission position according to the present invention;

FIG. 72 is a side and plane view showing a transmission control panel whose transmission lever is in a thirteenth-stage transmission position according to the present invention;

FIG. 73 is a side and plane view showing a transmission control panel whose transmission lever is in a fourteenth-stage transmission position according to the present invention;

FIG. 74 is a side and plane view showing a transmission control panel whose transmission lever is in a fifteenth-stage transmission position according to the present invention;

FIG. 75 is a side and plane view showing a transmission control panel whose transmission lever is in a high-stage transmission neutral position according to the present invention;

FIG. 76 is a schematic view showing a handle according to the present invention;

FIG. 77 is a schematic view showing a central portion of the handle according to the present invention;

FIG. 78 is a perspective view showing a steering device according to the present invention;

FIG. 79 is a side view showing relationship between a fixed central extension shaft of the steering wheel and a rotary shaft of the steering wheel of the steering device according to the present invention;

FIG. 80 shows a steering device according to another embodiment of the present invention; and

FIG. 81 shows overall configuration of the brake device according to the present invention.

### BEST MODE FOR CARRYING OUT THE INVENTION

A 4-wheel drive of the present invention includes rotary pumps 31, 58 receiving engine output of a vehicle via a shaft 100a to rotate a rotator 201 for pressing and supplying liquid to pipes 30, 28, 29, 41, and recovering the liquid passing through the pipes 30, 28, 29, 41; a main shaft 100 for transmitting power to front and rear wheels; a plurality of hydraulic rotary machines 32-36, 75-78 coupled to the main shaft 100 in multi stages to rotate the main shaft 100 by means of hydraulic pressure; pipes 30, 28, 29, 41 for supplying and recovering liquid pressed in the rotary pumps 31, 58 to/from the hydraulic rotary machines 32-36, 75-78; a plurality of selection valves 1-16, 6a-15a, 37-40 installed to the pipes 30, 28, 29, 41 to open or close liquid supply to the hydraulic rotary machines 32-36, 75-78; and an electronic control device for opening or closing the selection valves 1-16, 6a-15a, 37-40 by sensing discharged hydraulic pressure of the rotary pumps 31, 58 or shifting of a transmission lever 160 so as to give optimum power transmission.

Here, since the hydraulic rotary machines 75-78 are rotated by means of the liquid supplied from the rotary pump 58 that presses and discharges liquid by means of rotating power of the main shaft 100, front wheel shafts 106, 107 and rear wheel shafts 108, 109 are rotated.

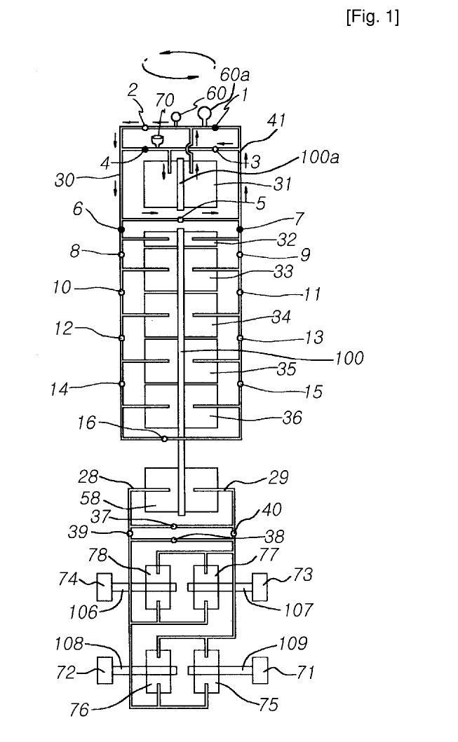

In the present invention, as shown in FIGS. 1 to 8, if the rotary pump 31 is rotated by a shaft 100a connected to an engine (not shown), the main shaft 100 coupled to the hydraulic rotary machines 32-36 is rotated. Then, the rotary pump 58 installed to a distal portion of the main shaft 100 is rotated, so the compressed liquid rotates the hydraulic rotary machines 75-78 installed to the front wheel shafts 106, 107 and the rear wheel shafts 108, 109, and thus front wheels 73, 74 and rear wheels 71, 72, thereby driving the vehicle in a 4-wheel driving way.

At this time, since the hydraulic rotary machines 75-78 are respectively installed to the front wheel shafts 106, 107 and the rear wheel shafts 108, 109, there is no need of a differential gear, and forward and rearward running may be selected according to an opening direction of the selection valves 1-16, 37-40.

Meanwhile, in the present invention, as shown in FIGS. 1 to 10 and 20 to 23, the 4-wheel rotary pump 58 is installed to the rear end of the main shaft 100 and the hydraulic rotary machines 77, 78 are mounted to the front wheel shafts 106, 107 for rotating the front wheel shafts. In addition, the hydraulic rotary machines 75, 76 are mounted to the rear wheel shafts 108, 109 for rotating the rear wheel shafts. Thus, when the pressed liquid is supplied from the rotary pump 58, the hydraulic rotary machines 75-78 are rotated to rotate the front wheels 73, 74 and the rear wheels 71, 72.

In addition, between the rotary pump 58 and the hydraulic rotary machines 75-78, the pipes 28, 29 for supplying and recovering liquid and the selection valves 37-40 for selecting front or rear wheel driving by regulating liquid flow by control of the electronic control device are installed.

At this time, the wheels may have different rotational speeds during the 4-wheel driving, and thus rotating speed of the hydraulic rotary machines 75-78 may have be different from each other. However, the pressed liquid extruded from one rotary pump 58 is supplied to all hydraulic rotary machines 75-78 by means of one pipe 28 or 29. Thus, in spite of different rotational speeds of the front and rear wheel shafts, the pressed liquid extruded from the rotary pump 58 is distributed to each hydraulic rotary machine 75-78 installed to each shaft suitably therefore and makes each of the front and rear wheel shafts rotated.

By using this configuration, the 4-wheel drive of the present invention may perfectly carry out the function of a differential gear under any running conditions.

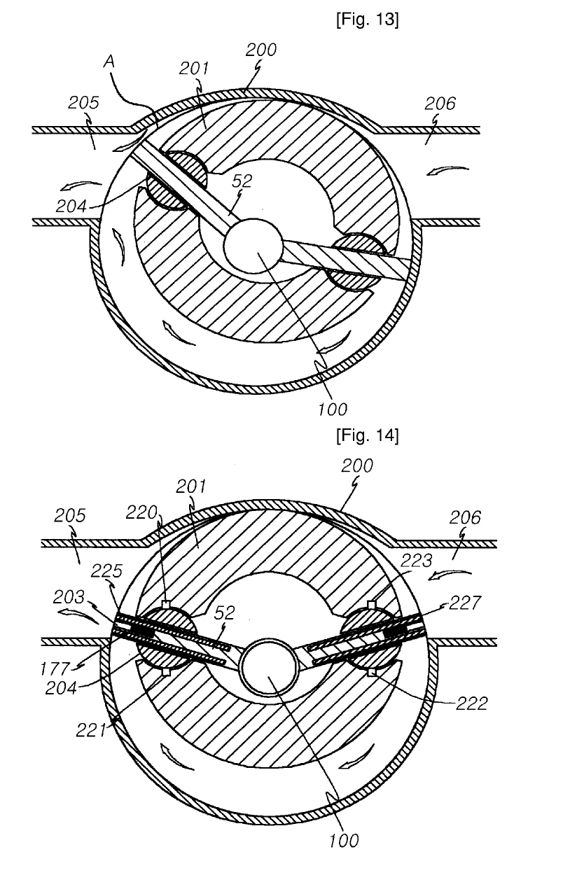

In the present invention, as shown in FIGS. 12 and 13, the rotary pumps 31, 58 presses and discharges liquid by rotation of the rotator 201 to which a wing 52 is coupled by means of a shaft 100a transmitting rotating force of the engine and also inhales liquid passing through the hydraulic rotary machines 32-36, 75-78. The hydraulic rotary machines 32-36, 75-78 rotates the rotator 201 coupled to the wing 52 by means of the liquid pressed by the rotary pumps 31, 58 and thereby rotates the main shaft 100. Thus, the rotator 201 is rotated by means of rotation of the rotator 201 to which the wing 52 is coupled.

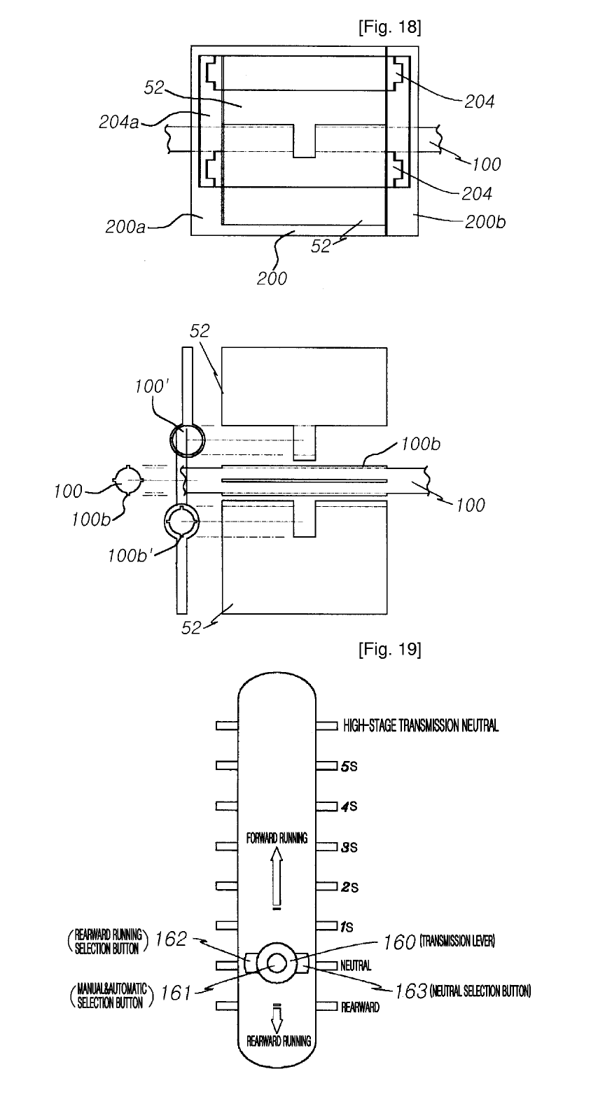

In addition, in the present invention, as shown in FIG. 18, the main shaft 100 rotated by the hydraulic rotary machines 32-36 is configured using a cylindrical rod to pass through the hydraulic rotary machines 32-36, so ring-shaped bushings are inserted to both walls of each hydraulic rotary machine, and the wing 52 should be inserted to the main shaft 100. At this time, one of all wings 52 should be firmly fixed to the main shaft 100, not to move.

At this time, another wing 52 should not be fixed to the main shaft 100 because a mutual angle of the wings 52 is frequently changed when the wings 52 rotates in the cylinder 200.

At this time, a tooth groove 100b′ is formed in the inner ring-shaped side of one wing 52 so as to be engaged with a tooth 100b of the main shaft 100, and a circular groove 100′, not a tooth, is formed in a ring of the other wing 52 to be engaged out of the tooth 100b.

Thus, one wing 52 is fixed by means of the tooth groove 100b′ and the tooth 100b, and the other wing 52 is not fixed to change its angle by means of the circular groove 100′.

In addition, as an alternative, the wing 52 may be fixed to the main shaft 100 in the following way.

That is to say, teeth are formed in the inner side of one wing 52 in all directions so as to be engaged with tooth grooves formed in the main shaft 100 in all directions, while a circular groove is formed in the other wing 52 without any tooth or tooth groove so that the other wing 52 is coupled out of the main shaft 100 to be freely rotatable.

In addition, in the present invention, a space (A) is formed in an upper portion of the cylinder 200 so that liquid is not compressed in the space (A) but discharged out to ensure normal rotation though the wing 52 is rotated close to the inner wall of the cylinder 200. An angle of the wing 52 is selected so that the wing 52 may contact with lower ends of an inlet hole 206 and an outlet hole 205.

The rotary pumps 31, 58 press liquid by rotating the shaft 100a and thus rotating the wing 52. The hydraulic rotary machines 32-36, 75-78 introduce the pressed liquid to rotate the wing 52, thereby rotating the shaft 100. Thus, the space (A) is formed to solve the problem that, when the wing 52 is rotating, the liquid is compressed in the cylinder 200 above the outlet hole 205 by means of the wing 52 to hinder rotation of the wing 52.

That is to say, since liquid for forming the space (A) is not compressed when the rotary pumps 31, 58 and the wing 52 of the hydraulic rotary machines 32-36, 75-78 are rotated in a clockwise direction, there is no problem in normal rotation.

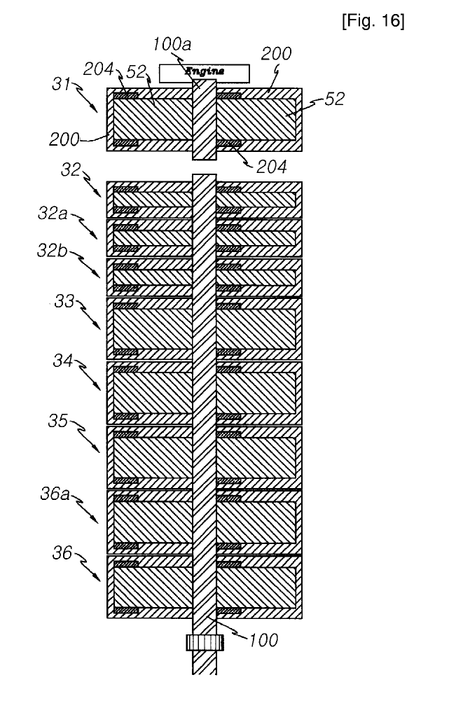

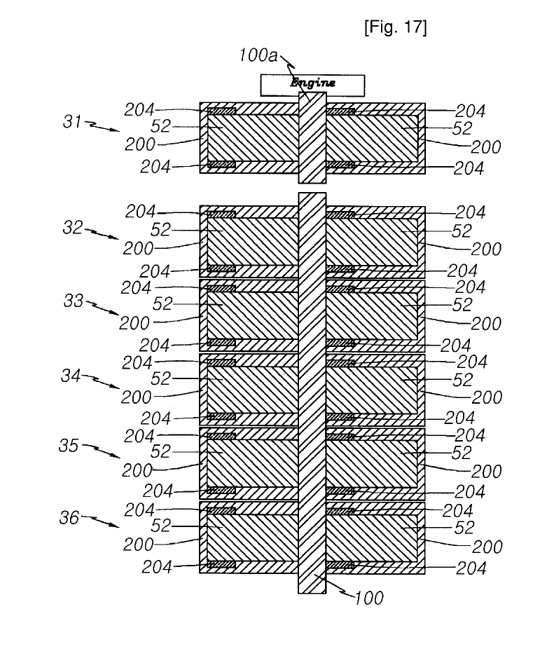

In addition, as shown in FIGS. 16 and 17, the hydraulic rotary machines 32-36, 75-78 may be independently configured and connected in series. At this time, power transmission is all transmitted to the main shaft 100.

That is to say, if the hydraulic rotary machines 32-36, 75-78 are configured independently, the multi-stage structure may be realized in a simple way, and careful attention is not needed for sealing of each hydraulic rotary machine. In addition, it is possible to control the number of hydraulic rotary machines 32-36, 75-78.

The rotary pumps 31, 58 of the present invention are configured as shown in FIG. 14 so that, when the rotator 201 is rotated due to rotation of the shaft 100a connected to the engine, a perfect circular front end of the wing 52 installed using sliding material to the rotator 201 by means of a wing hole 204 is rotated in close contact with the inner wall of the perfect circular cylinder to inhale liquid through the inlet hole 206 and discharge the pressed liquid through the outlet hole 205. In addition, linings 203, 220, 221, 222, 223, 224, 225, 226, 227 are elastically inserted to the front end of the wing 52 and the both sides of the rotator 201 by means of a spring 177 (or, a spring attached to each lining). Thus, when the rotator 201 is rotating, the wing 52 closed adhered to the perfect circular front end of the rotator 201 and the wall of the cylinder 200 is rotated to make the perfect circular outer wall of the rotator 201 closely contacted with the inner wall of the perfect circular cylinder 200, thereby pressing and discharging liquid.

In addition, the linings 203, 220, 221, 222, 223, 224, 225, 226, 227 are mounted to all rotary pumps and all hydraulic rotary machines, including the above.

Here, the wing 52 coupled to the rotator 201 may easily rotate if the wing 52 has an angle out of the wing hole 204 with respect to the rotator 201.

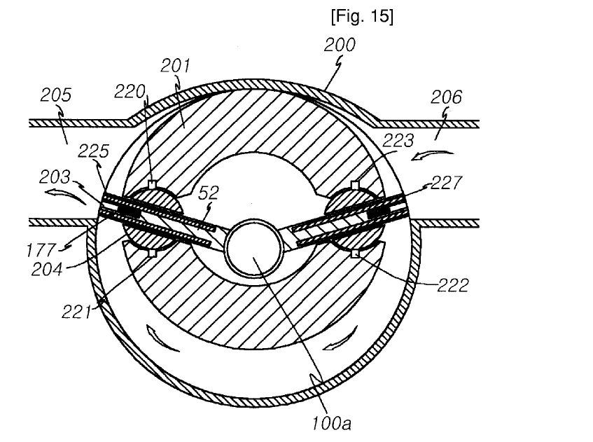

In addition, the hydraulic rotary machines 32-36, 75-78 of the present invention rotates the main shaft 100 by rotating the rotator 201 like the rotary pumps 31, 58 as shown in FIG. 15. The rotary pumps 31, 58 play a role of pressing liquid by external power of a vehicle engine and discharging the liquid, and it is different only on this point that the hydraulic rotary machines 32-36, 75-78 rotates the rotator 101 using the hydraulic pressure increased by the rotary pump 31, 58 so that the main shaft 100.

In addition, while the engine is operating, the rotary pumps 31, 58 continuously press and discharge liquid and also recover liquid from the hydraulic rotary machines 32-36, 75-78 as much as discharged. In addition, the hydraulic rotary machines 32-36, 75-78 rotate the main shaft 100 and the front and rear wheel shafts 106-109 only when the liquid pressed by the rotary pump 31, 58 is introduced, and does not give any force to the main shaft 100 and the front and rear wheel shafts 106-109 if the pressed liquid is not supplied thereto, thereby making the main shaft 100 and the front and rear wheel shafts 106-109 be idle. It is difference between the rotary pumps 31, 58 and the hydraulic rotary machines 32-36, 75-78.

Meanwhile, as shown in FIG. 18 in the present invention, the wing hole 204 into which the wing 52 made of sliding material is inserted couples a support 204a into cover plates 200a, 200b of the cylinder 200 so that the wing 52 is closely adhered to the inner wall of the cylinder 200 not to leak liquid through a gap and also so as to facilitate movement. In addition, it stabilizes movement of the wing 52 to prevent the generation of breakdown and also presses liquid to be discharged out.

In the present invention as mentioned above, in FIG. 18, the support 204a is coupled to the left cover plate 200a, the wing 52 and the shaft 100 are coupled in the cylinder 200, and then the cover plate 200b into which the support 204a is inserted is coupled at the right, thereby completing assembling.

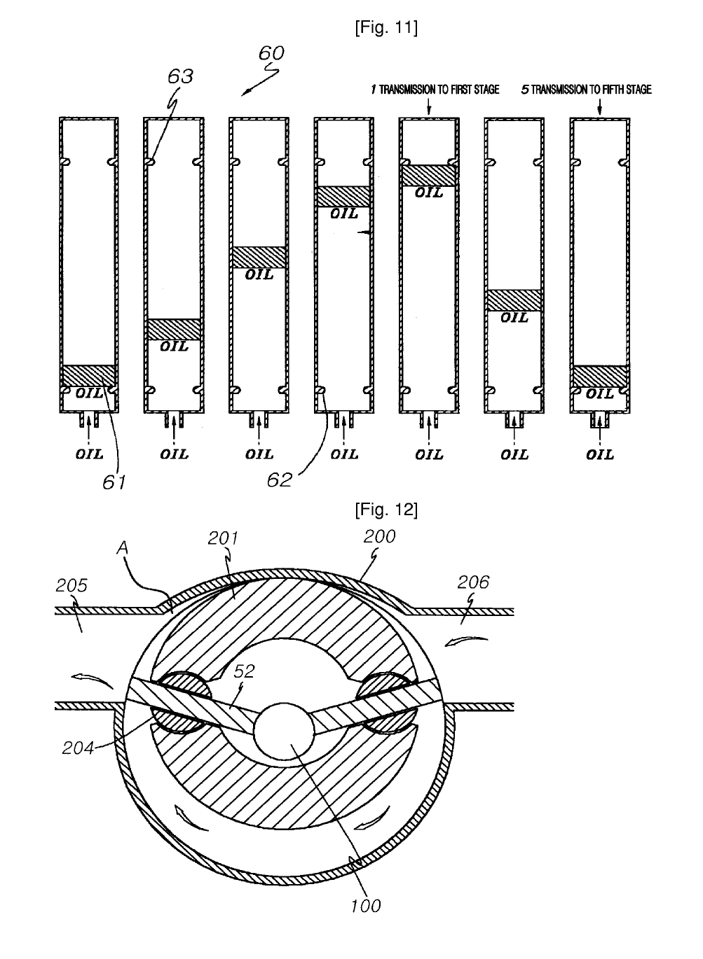

The liquid selection valves 1-16, 6a-15a, 37-40 of the present invention select opening or closing by means of an electric signal applied from the electronic control device. By means of the electronic control device, as a moving body 61 of a transmission control oil pressure gauge 60 shown in FIG. 11 is moved according to interior hydraulic pressure, a contact point 62 is selected to open or close the selection valves 1-16, 6a-15a, 37-40. In addition, as the transmission lever 160 shown in FIG. 19 is manually moved, the selection valves 1-16, 6a-15a, 37-40 are opened or closed. In addition, the selection valves 1-16, 6a-15a, 37-40 are opened or closed by recognition of change of contact points 62, 63 of the transmission control oil pressure gauge 60 and movement of the transmission lever 160.

In the present invention, a liquid supplement chamber 70 is installed so as to store and supplement liquid in case liquid passing in the pipes 28, 29, 30, 41 is in surplus or shortage.

The transmission lever 160 acts as a manual transmission when the lever 160 is moved as shown in FIG. 19. The manual transmission using the transmission lever 160 is activated only when a manual selection button 161 installed thereabove is pressed, and in other cases the automatic transmission is used. A rearward running selection button 162 is installed to the side of the transmission lever 162. In case of rearward running, a user presses the rearward running selection button 162 and then moves the transmission lever 160 to a rearward running position of the transmission control panel 190.

At this time, once pressed, the manual selection button 161 and the rearward running selection button 162 keep the pressed state to ensure the selection of manual transmission and rearward running. These buttons 161, 162 are released if pressed once more, and moved to their original positions.

In this configuration, the rotary pump 31 of the present invention is directly connected to the vehicle engine and the shaft 100a, so, if a vehicle is starting, the rotary pump 31 is rotated to press and discharge liquid. The rotary pump 31 stops only when the engine stops.

In the automatic transmission state, if a main key of the vehicle is taken out from a key box, all selection valves are released in any event, and accordingly the engine stops, the rotary pumps and hydraulic rotary machines completely stop, and thus the car is stopped.

However, in the manual transmissions state, according to positions of the transmission lever and the selection buttons, corresponding selection valve is opened or closed.

Now, an idle state when the rotary pump 31 is driven by starting the engine is described.

The idle state corresponds to an initial state, so the selection valves 1, 4, 6, 7, 37-40 are closed and the selection valves 2, 3, 5, 8-16 are opened, as shown in FIG. 1.

Then, the liquid pressed by the rotary pump 31 repeats flowing through the selection valves 2, 3, 5 and returning to the rotary pump 31 as indicated by arrows in the figure. Thus, introduction of liquid into the hydraulic rotary machines 32-36 is completely prevented, and the main shaft 100 is not rotated and the vehicle keeps a stopped state.

That is to say, it is identical to the state that a vehicle is not moving when an engine is started with the gear in a neutral state.

In the idle state for advancing as shown in FIG. 1, the selection valves 2, 3, 5, 8-16, 37-40 are opened and the selection valves 1, 4, 6, 7 are closed, and the vehicle is not operated in a completely stopped state.

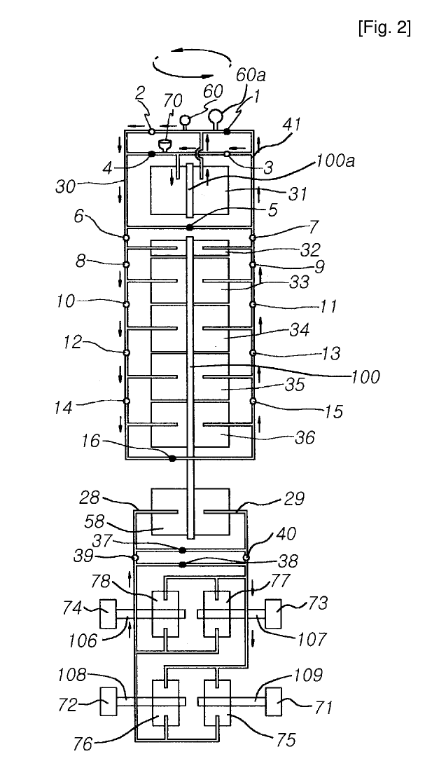

If it becomes a first-stage transmission, as shown in FIG. 2, the selection valves 2, 3, 6-15, 39, 40 are opened and the selection valves 1, 4, 5, 16, 37, 38 are closed, and accordingly the liquid pressed by the rotary pump 31 is flowed as indicated by arrows in the figure.

Thus, the hydraulic rotary machines 32-36 installed in multi stages rotate the interior rotator 201 by means of increased hydraulic pressure supplied from the rotary pump 31. If the rotator 201 is rotated, the main shaft 100 is also rotated. If the main shaft 100 is rotated, the rotary pump 58 installed to the rear end of the main shaft 100 is rotated to supply the pressed liquid to the hydraulic rotary machines 75-78 installed to the front and rear wheel shafts 106-109. Thus, the hydraulic rotary machines 75-78 rotates the front and rear wheel shafts 106-109, thereby making the vehicle advancing.

At this time, it is impossible that all of the hydraulic rotary machines 32-36, 75-78 are operated to drive the main shaft 100 rapidly by the hydraulic pressure increased by the rotary pump 31, but since the hydraulic rotary machines 32-36 are all operated, a driving force required for the vehicle is greatly transmitted.

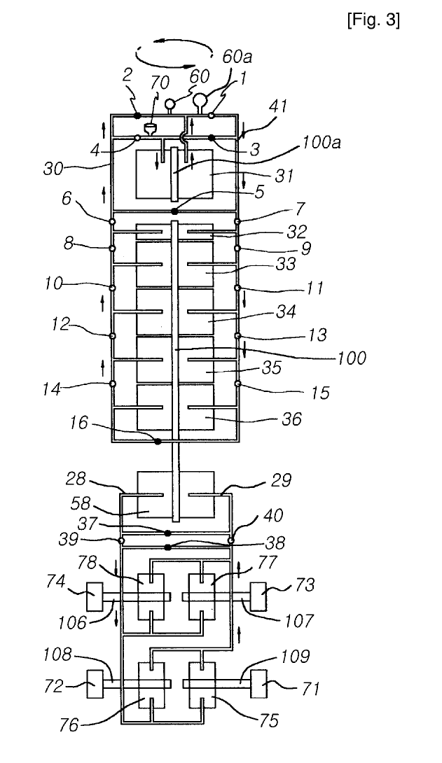

As shown in FIG. 3, at a first rearward transmission as shown in FIG. 3, the selection valves 1, 4, 6-15, 39, 40 are opened and the selection valves 2, 3, 5, 16, 37, 38 are closed.

Then, the liquid pressed in the rotary pump 31 flows in a direction opposite to the case of the first-stage driving shown in FIG. 2. Accordingly the hydraulic rotary machines 32-36 installed in multi stages inversely rotate the rotator 201 due to hydraulic pressure supplied from the rotary pump 31. Since the main shaft 100 is inversely rotated as the rotator 201 is inversely rotated, the vehicle moves rearward with first rearward transmission.

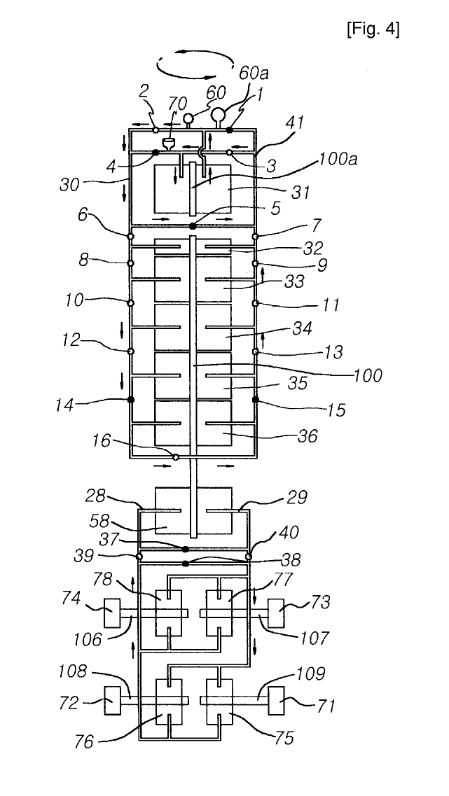

As shown in FIG. 4, at the second-stage transmission, the selection valves 2-3, 6-13, 16, 39, 40 are opened and the selection valves 1, 4, 5, 14, 15, 37, 38 are closed. At this time, operation of the main shaft 100 is identical to the above description.

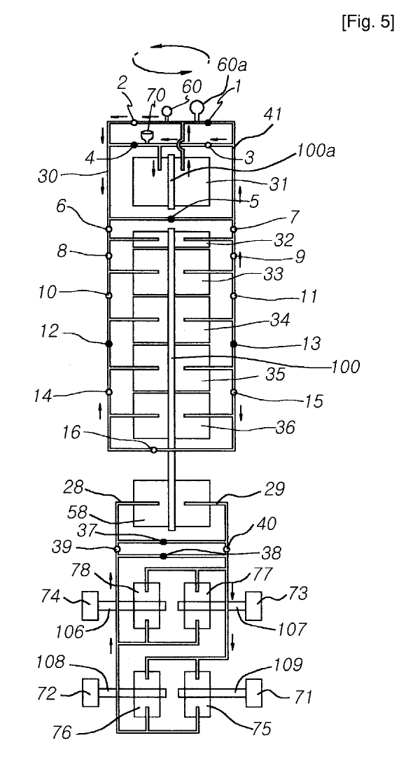

As shown in FIG. 5, at the third-stage transmission, the selection valves 2, 3, 6-11, 14-16, 39, 40 are opened and the selection valves 1, 4, 5, 12, 13, 37, 38 are closed.

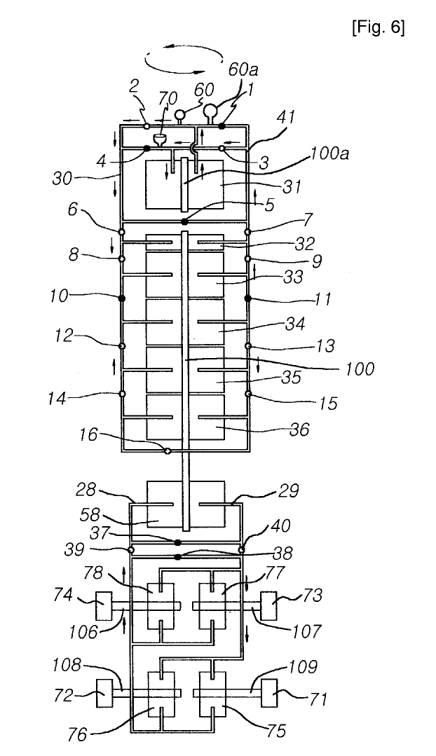

As shown in FIG. 6, at the fourth-stage transmission, the selection valves 2, 3, 6-9, 12-16, 39, 40 are opened and the selection valves 1, 4, 5, 10, 11, 37, 38 are closed.

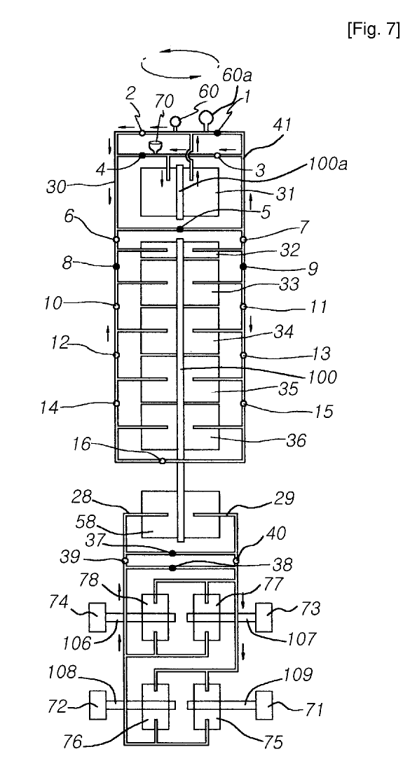

As shown in FIG. 7, at the fifth-stage transmission, the selection valves 2, 3, 6, 7, 10-16, 39, 40 are opened and the selection valves 1, 4, 5, 8, 9, 37, 38 are closed. As the gear stage is increased, the number of operating hydraulic rotary machines is decreased to enable rapid running by means of high-speed rotation.

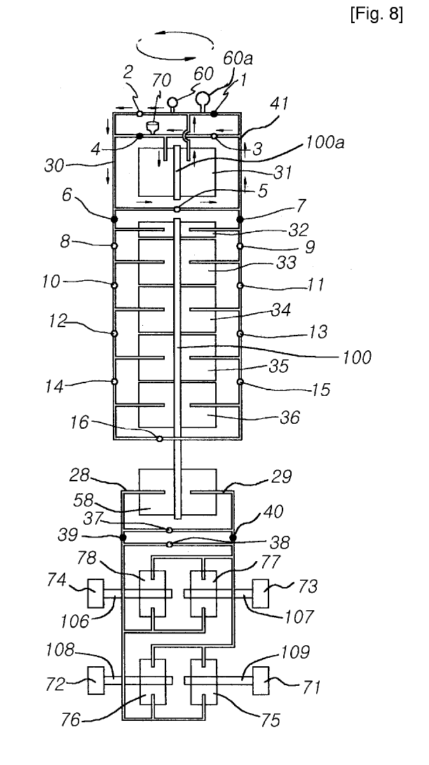

As shown in FIG. 8, if the transmission lever 160 is in a neutral transmission position, the selection valves become a neutral state wherein the selection valves 2, 3, 5, 8-16, 37, 38 are opened and the selection valves 1, 4, 6, 7, 39, 40 are closed.

At this time, if the rearward running selection button 162 of the transmission lever 160 is pressed, its locking state is released so that the transmission lever 160 may move to a rearward transmission position. if the transmission lever 160 is returned to the neutral transmission position from the rearward running transmission position, the rearward running selection button 162 is automatically protruded out for locking.

As mentioned above, the transmission lever 160 may be moved from the neutral position to the rearward running transmission position on the transmission control panel 190 only when the rearward running selection button 162 is pressed. In addition, such a position change is inevitable for rearward running of the vehicle.

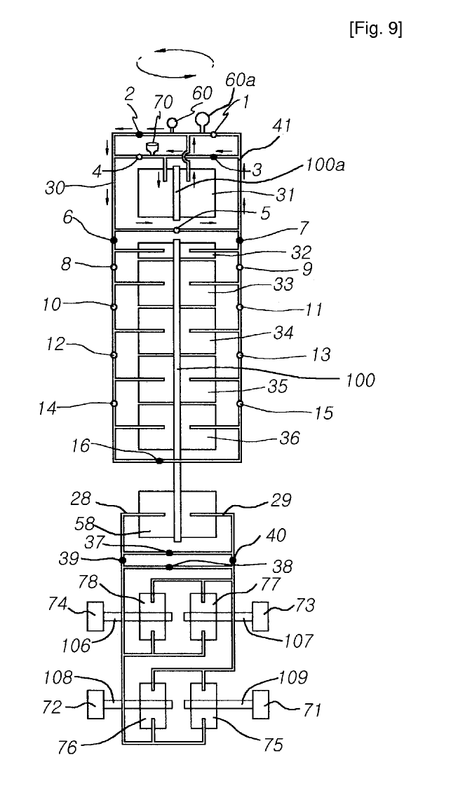

As shown in FIG. 9, at the idle state for rearward running, the selection valves 1, 4, 5, 8-15 are opened and the selection valves 2, 3, 6, 7, 16, 37-40 are closed. At this time, only the rotary pump 31 is rotated, but the rotary pump 58 and all hydraulic rotary machines are stopped, so the vehicle stops its operation.

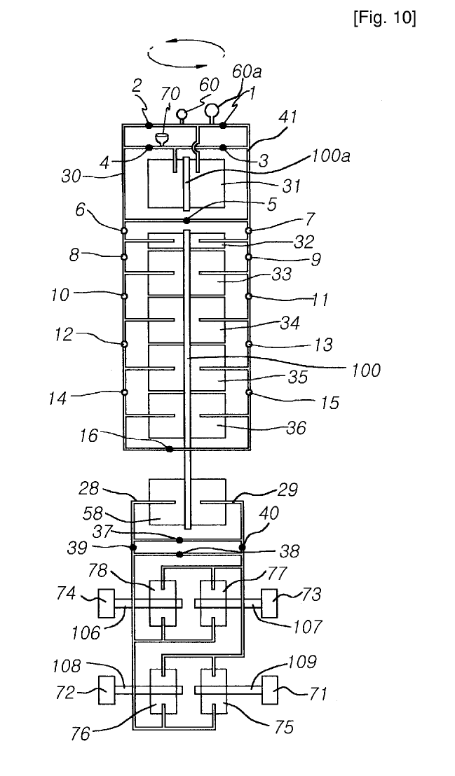

As shown in FIG. 10, when the engine is stopped for stoppage or parking, the selection valves 6, 15 are opened and the selection valves 1-5, 37-40, 16 are closed.

As mentioned above, the 4-wheel drive of the present invention may shift gears automatically according to a running speed of the vehicle or manually. Now, the procedure of automatic transmission is described with reference to FIG. 11 using the transmission control oil pressure gauge 60.

That is to say, in FIG. 11, the contact points 62, 63 are electrodes, and the moving body 61 is an electric conductor.

If hydraulic pressure in the pipe 30 is increased as the load of vehicle increases, the hydraulic pressure in the transmission control oil pressure gauge 60 is also increased to push up the moving body 61. If the moving body 61 is pushed up to the contact points 63, the moving body 61 electrically connects the contacts points 63 at both sides to allow flow of electricity. Then, the electric current is flowed to the electronic control device to generate a signal for moving the transmission lever 160 to a low-stage transmission position. Since The transmission lever 160 is automatically moved to a low-stage transmission position, speed is slowed but power becomes stronger.

In addition, to the contrary, if the hydraulic pressure in the transmission control oil pressure gauge 60 is decreased, the moving body 61 moves down to connect the contact points 62 at both sides, so electric current is flowed to the electronic control device, which functions to move the transmission lever 160 to a high-stage transmission position. Thus, the vehicle is operated more rapidly but the driving power becomes weaker.

The present invention makes the gear shifting based on the above principle, and it is also possible that hydraulic pressure or load is sensed using a spring in addition to the above.

If the moving body 61 moves according to the hydraulic pressure in the pipe 30, the electronic control device senses the movement of the moving body 61 using the contact points 62, 63, which may be used as variables for changing speed. Thus, since the electronic control device manipulates the selection valves 1-16 depending on which contact points 62, 63 are sensed, impact wave is generated due to instant gear shifting whenever the transmission work is conducted, so there is needed a damping means for absorbing the impact wave. Therefore, an impact wave damping chamber 60a that is a sealed air chamber is installed beside the transmission control oil pressure gauge 60 between the selection valve 1 and the selection valve 2 so as to absorb the generated impact waves.

Now, the procedure for manually shifting gears by manipulating the transmission lever 160 as shown in FIG. 19 is described.

In order to shift gears by moving the transmission lever 160, a user selects a gear by moving the transmission lever 160 according to load and speed of a vehicle like the existing manual transmission vehicle. At this time, the electronic control device recognizes position change of the transmission lever 160 and then controls opening and closing of the selection valves 1-16, 37-40.

At this time, the transmission procedure is conducted as mentioned above.

Meanwhile, a manual and automatic transmission selection button 161 is provided to the transmission lever 160 so as to select manual transmission once the button 161 is pressed, and also select automatic transmission when the button 161 is pressed once more to be protruded out. If the rearward running selection button 162 is pressed, the locking is released so that the transmission lever 160 may be moved from the neutral position of the transmission control panel 190 to the rearward running transmission position.

If the transmission lever 160 is moved to the rearward running transmission position as mentioned above, a user releases the brake and steps on the accelerator, and then the rearward running is initiated.

In addition, if the transmission lever 160 is returned to the neutral position from the rearward running transmission position, the rearward running selection button 162 is automatically protruded out at the same time.

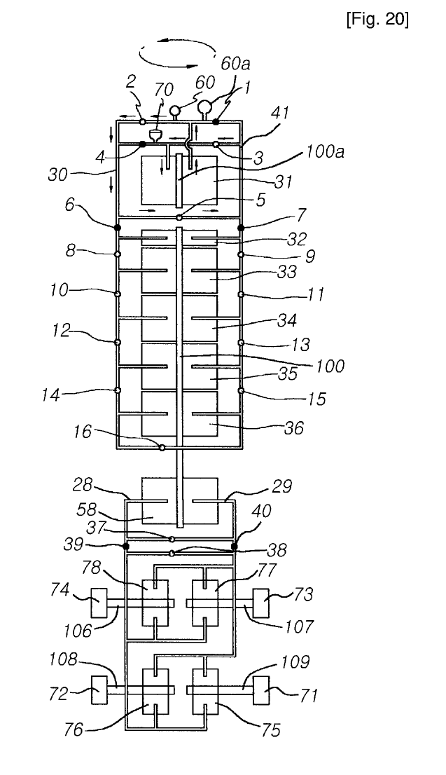

Meanwhile, as shown in FIG. 20, when the brake is operating during running in an automatic transmission state, the selection valves 2, 3, 5, 8-16, 37-38 are opened and the selection valves 1, 4, 6, 7, 39-40 are closed. At this time, the transmission lever 160 is in a neutral transmission state.

If transmission is changed to the neutral state, fuel consumption is significantly reduced. At any time that the vehicle is running or stopping in an automatic transmission state, the transmission is changed to the neutral state if the brake is stepped down.

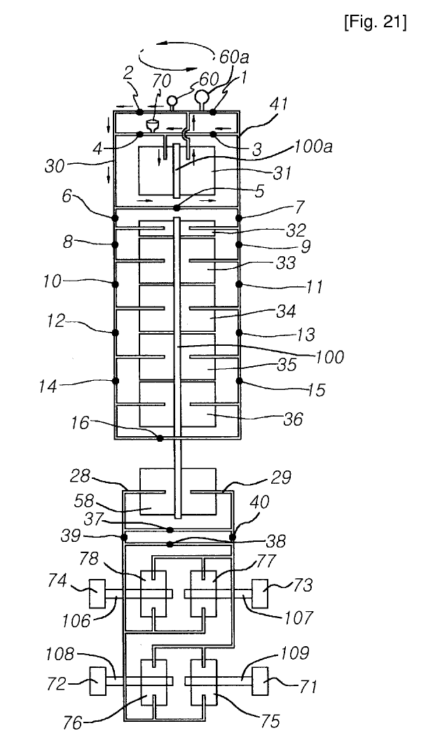

In FIG. 21, when a vehicle is stopped in an automatic transmission state, all selection valves are closed.

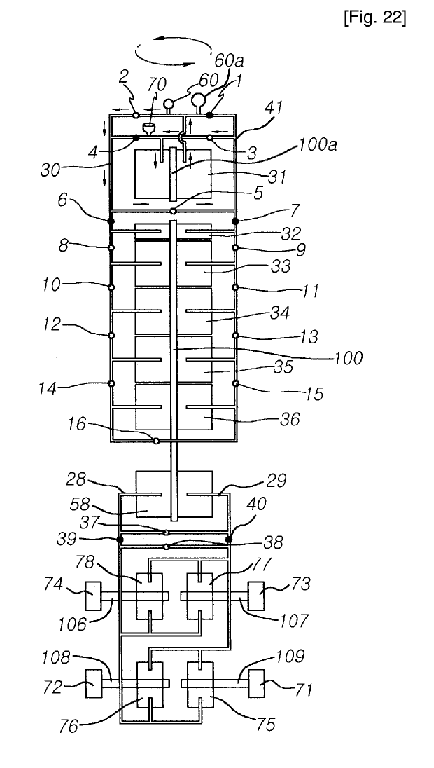

FIG. 22 shows a neutral state, where the selection valves 1, 4, 6, 7, 39, 40 are closed and the other valves are all opened.

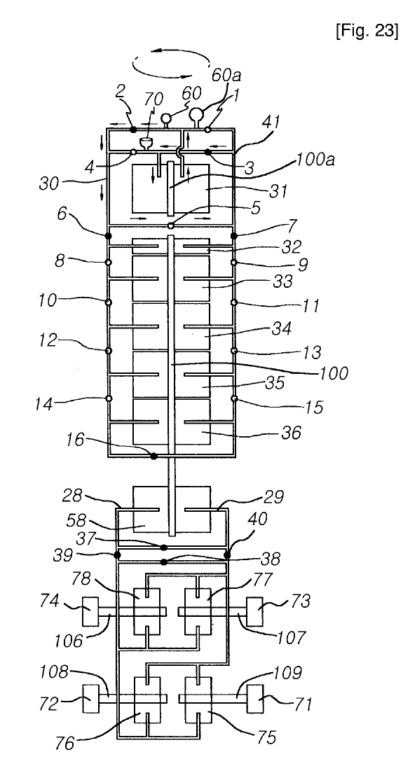

In FIG. 23, if the rearward running selection button 162 is pressed, the locking is released so that the transmission lever 160 may be moved from the neutral transmission position to the rearward running selection position.

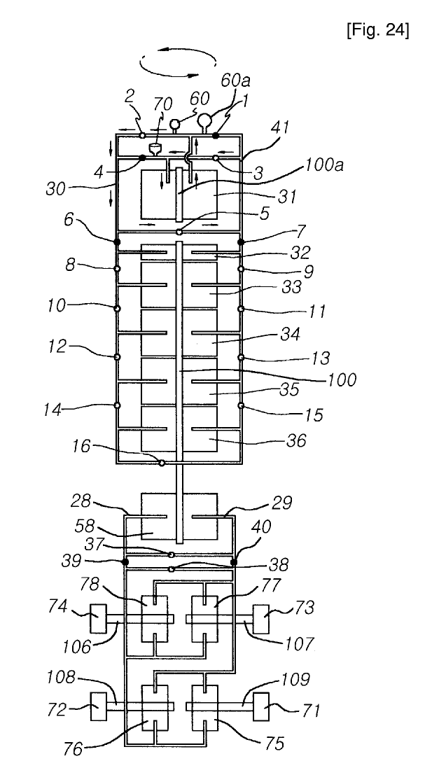

In FIG. 24, though all selection valves are opened in a neutral state, among them, the selection valves 1, 4, 6, 7, 39, 40 are closed during running.

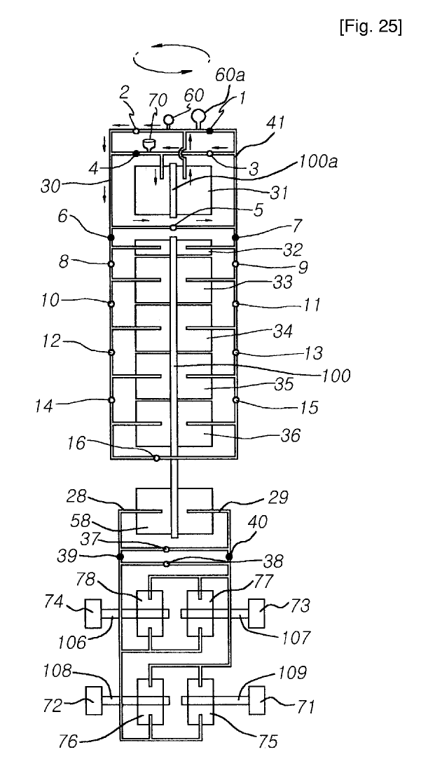

In FIG. 25, though all selection valves are open in a high-stage transmission neutral state, the selection valves 1, 4, 6, 7, 39, 40 are closed among them during running.

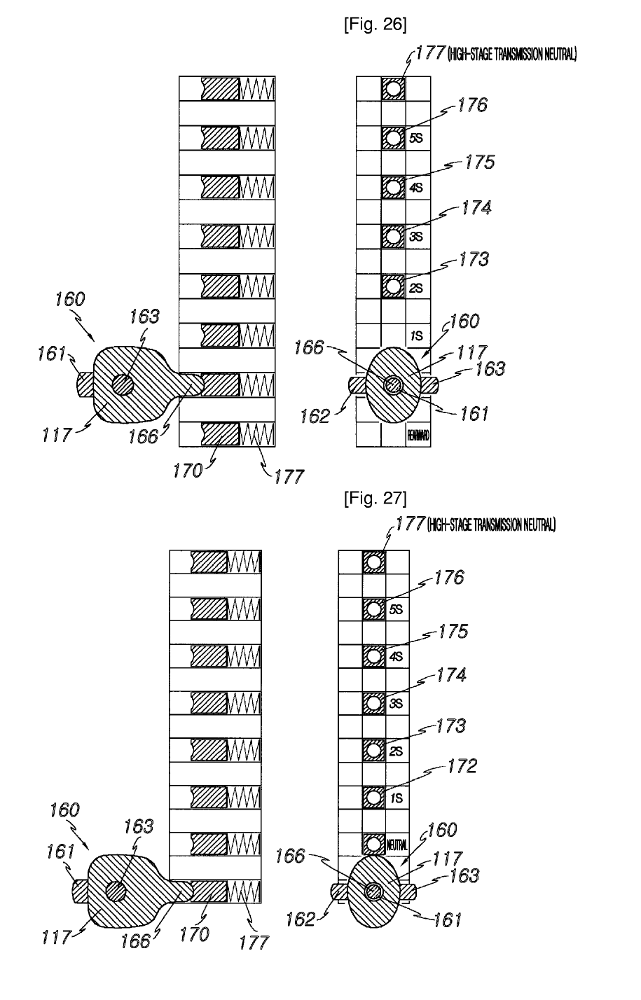

In FIG. 26, when the transmission lever 160 is positioned in a neutral transmission position of the transmission control panel 190, the selection valves 2, 3, 5, 8-16, 37, 38 are opened and the selection valves 1, 3, 6, 7, 39, 40 are closed.

FIG. 27 shows that the transmission lever 160 is positioned to the rearward running selection position of the transmission control panel 190. At this time, the selection valve 1, 4, 6-15, 39, 40 are opened and the selection valves 2, 3, 5, 16, 37, 38 are closed.

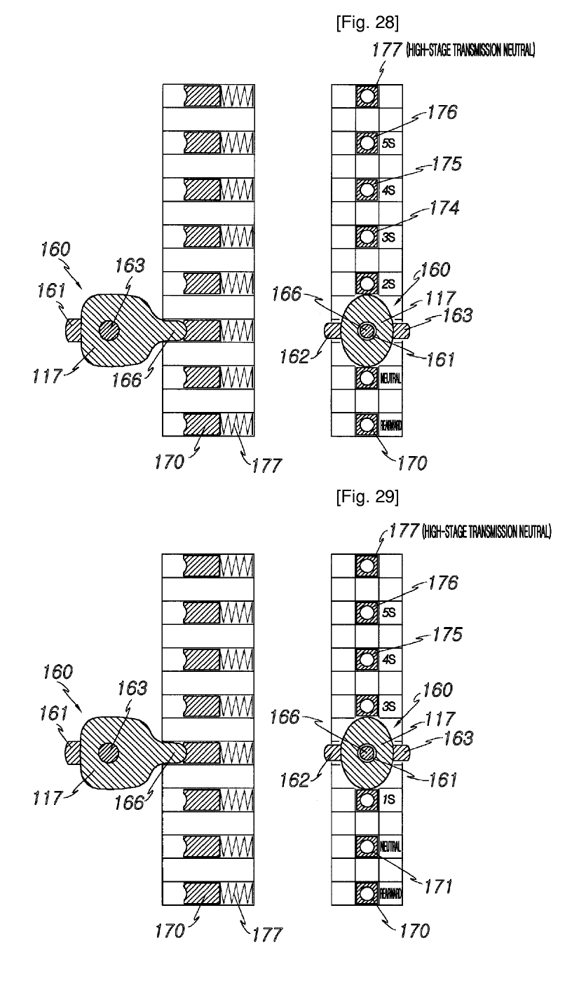

FIG. 28 shows that the transmission lever 160 is positioned in a first-stage transmission position of the transmission control panel 190. At this time, the selection valves 2, 3, 6-15, 39, 40 are opened and the selection valves 1, 4, 5, 16, 37, 38 are closed.

FIG. 29 shows that the transmission lever 160 is positioned in a second-stage transmission position of the transmission control panel 190.

If the transmission lever 160 is positioned in the second-stage transmission position, the selection valves 2, 3, 6-13, 16, 39, 40 are opened and the selection valves 1, 4, 5, 14, 15, 37, 38 are closed.

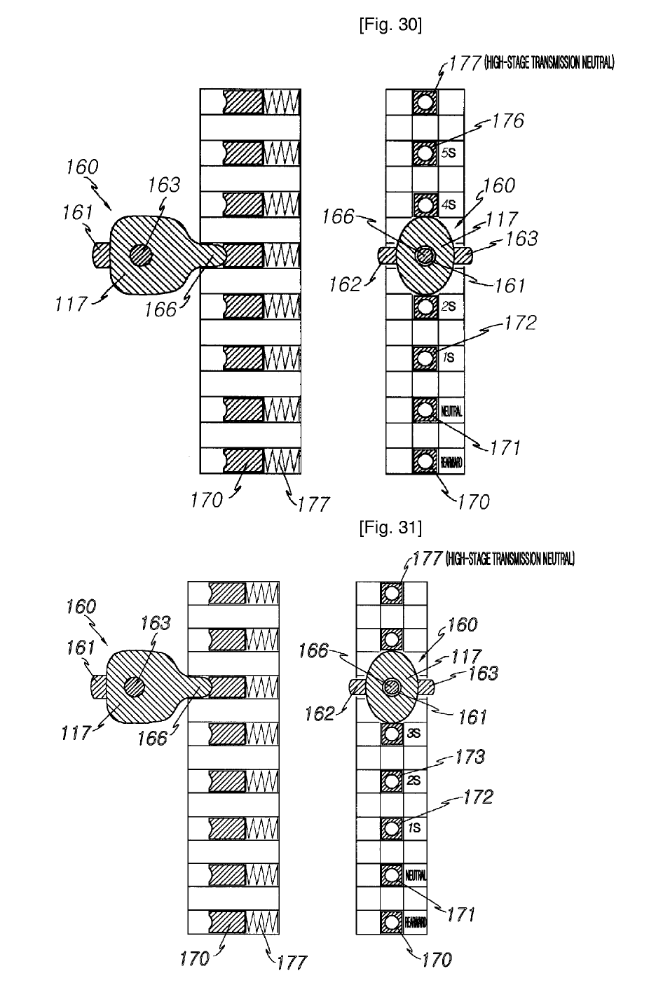

In FIG. 30, if the transmission lever 160 is positioned in a third-stage transmission position of the transmission control panel 190, the selection valves 2, 3, 6-11, 14-16, 39, 40 are opened and the selection valves 1, 4, 5, 12, 13, 37, 38 are closed.

FIG. 31 shows that the transmission lever 160 is positioned in a fourth-stage transmission position of the transmission control panel 190. In case of 4-wheel drive, the selection valves 2, 3, 6-9, 12-16, 39, 40 are opened and the selection valves 1, 4, 5, 10, 11, 37, 38 are closed.

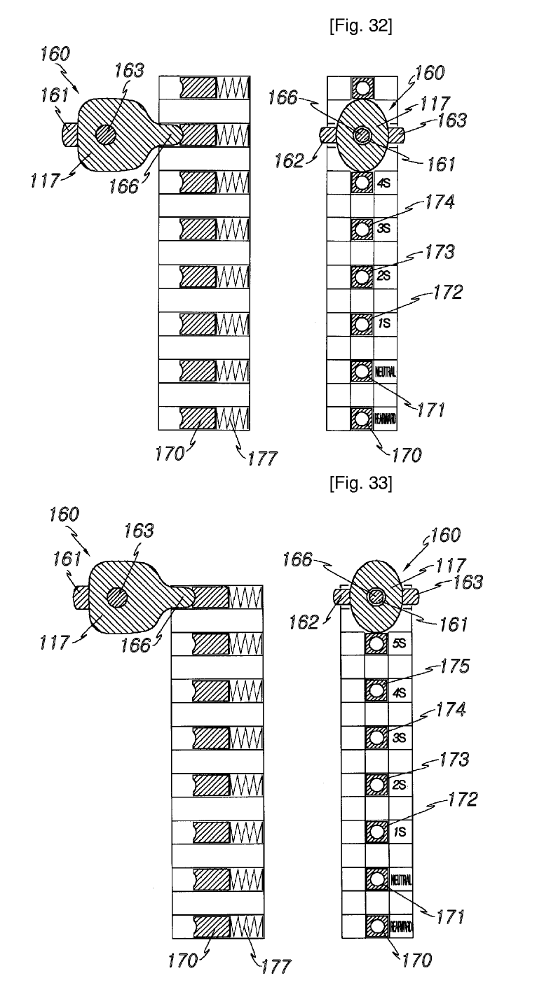

FIG. 32 shows that the transmission lever 160 is positioned in a fifth-stage transmission position of the transmission control panel 190. The selection valves 2, 3, 6, 7, 10-16, 39, 40 are opened and the selection valves 1, 4, 5, 8, 9, 37, 38 are closed.

As shown in FIG. 32, if the transmission lever 160 is positioned in a high-stage transmission position of the transmission control panel 190 during running, the selection valves 2, 3, 5, 8-16, 37-40 are opened and the selection valves 1, 4, 6, 7 are all closed.

Now, a 4-wheel drive according to another embodiment of the present invention will be described in detail.

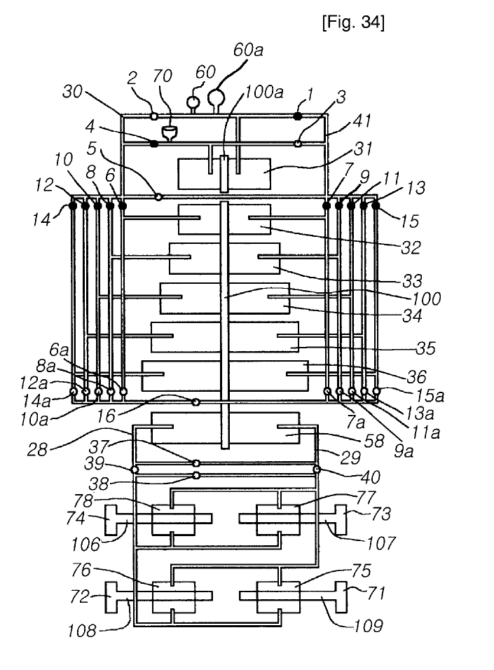

That is to say, FIGS. 34 to 75 are related to a transmission that operates as a 15-stage transmission by installing five hydraulic rotary machines 32-36.

At this time, a liquid inhaling volume of the rotary machine 32 is identical to a liquid discharging volume of the rotary pump 31, a liquid inhaling volume of the rotary machine 33 is two times of a liquid discharging volume of the rotary pump 31, a liquid inhaling volume of the rotary machine 34 is three times of a liquid discharging volume of the rotary pump 31, a liquid inhaling volume of the rotary machine 35 is four times of a liquid discharging volume of the rotary pump 31, and a liquid inhaling volume of the rotary machine 36 is five times of a liquid discharging volume of the rotary pump 31.

Thus, if the rotary pump 31 rotates the rotary machine 32, speed and power of the rotary machine 32 are identical to those of the rotary pump 31, but when the rotary machine 33 is rotated using a discharged hydraulic pressure of the rotary pump 31, speed is ½ and power is two times, and when the rotary machine 34 is rotated using a discharged hydraulic pressure of the rotary pump 31, speed is ⅓ and power is three times, when the rotary machine 35 is rotated using a discharged hydraulic pressure of the rotary pump 31, speed is ¼ and power is four times, and when the rotary machine 36 is rotated using a discharged hydraulic pressure of the rotary pump 31, speed is ⅕ and power is five times, and when the rotary machines 33, 35 are rotated at the same time using a discharged hydraulic pressure of the rotary pump 31, speed is ⅙ and power is six times, and when the rotary machines 33, 36 are rotated at the same time using a discharged hydraulic pressure of the rotary pump 31, speed is 1/7 and power is seven times, and when the rotary machines 34, 36 is rotated using a discharged hydraulic pressure of the rotary pump 31, speed is ⅛ and power is eight times, and when the rotary machines 35, 36 are rotated at the same time using a discharged hydraulic pressure of the rotary pump 31, speed is 1/9 and power is nine times, and when the rotary machines 33, 34, 36 are rotated at the same time using a discharged hydraulic pressure of the rotary pump 31, speed is 1/10 and power is ten times, and when the rotary machines 33, 35, 36 are rotated at the same time using a discharged hydraulic pressure of the rotary pump 31, speed is 1/11 and power is eleven times, and when the rotary machines 34, 35, 36 are rotated at the same time using a discharged hydraulic pressure of the rotary pump 31, speed is 1/12 and power is twelve times, and when the rotary machines 32, 34, 35, 36 are rotated at the same time using a discharged hydraulic pressure of the rotary pump 31, speed is 1/13 and power is thirteen times, and when the rotary machines 33, 34, 35, 36 are rotated at the same time using a discharged hydraulic pressure of the rotary pump 31, speed is 1/14 and power is fourteen times, and when the rotary machines 32, 33, 34, 35, 36 are rotated at the same time using a discharged hydraulic pressure of the rotary pump 31, speed is 1/15 and power is fifteen times.

As mentioned above, even the small number of hydraulic rotary machines 32-36 may reduce speed significantly and increase power awfully.

It will be described below in more detail.

FIG. 34 is a schematic view showing a 4-wheel drive according to another embodiment of the present invention in an idle state. At this time, the liquid selection valves 1, 4, 6-15 are closed and the other liquid selection valves are all opened.

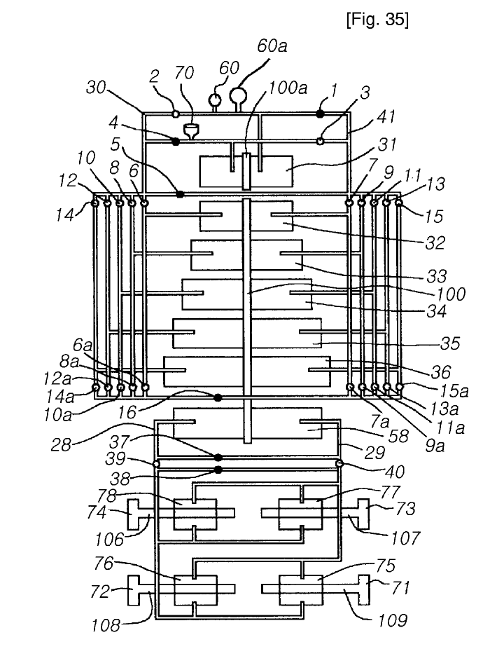

FIG. 35 is a schematic view showing a 4-wheel drive according to another embodiment of the present invention in a first forward stage. At this time, the liquid selection valves 1, 4, 5, 16, 37, 38 are closed and the other liquid selection valves are all opened.

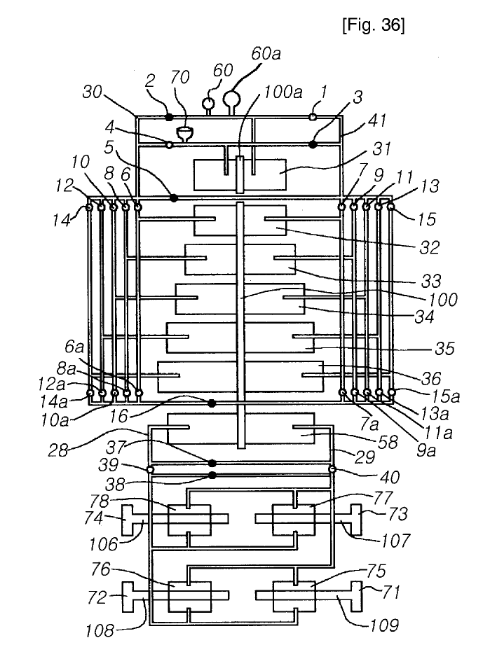

FIG. 36 is a schematic view showing a 4-wheel drive according to another embodiment of the present invention in a first rearward stage. At this time, the liquid selection valves 2, 3, 5, 16, 37, 38 are opened and the other liquid selection valves are closed.

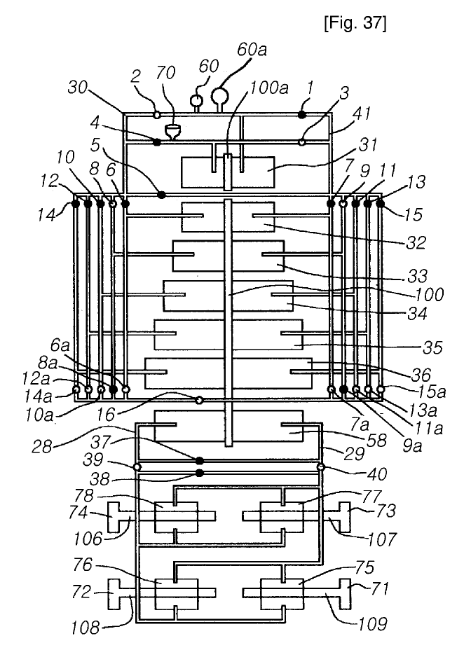

FIG. 37 is a schematic view showing a 4-wheel drive according to another embodiment of the present invention in a second forward stage. At this time, the liquid selection valves 2, 3, 8, 9, 16, 6a, 7a, 10a-15a, 39, 40 are opened and the liquid selection valves 1, 4, 5-7, 10-15, 8a, 9a, 37, 38 are closed.

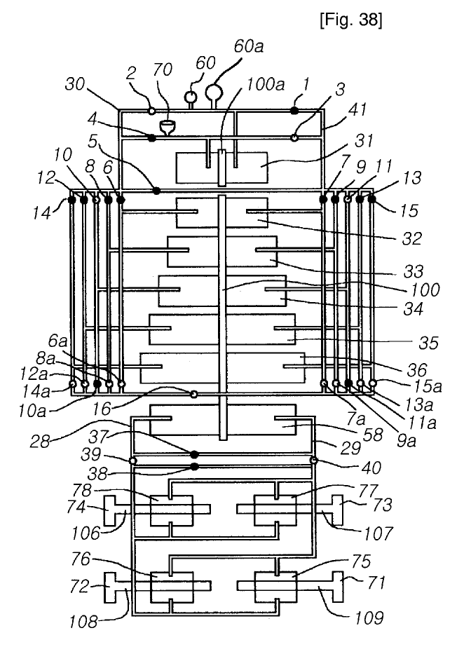

FIG. 38 is a schematic view showing a 4-wheel drive according to another embodiment of the present invention in a third forward stage. At this time, the liquid selection valves 2, 3, 10, 11, 16, 6a-9a, 12a-15a, 39, 40 are opened and the liquid selection valves 1, 4, 5, 6-9, 12-15, 10a, 11a, 37, 38 are closed.

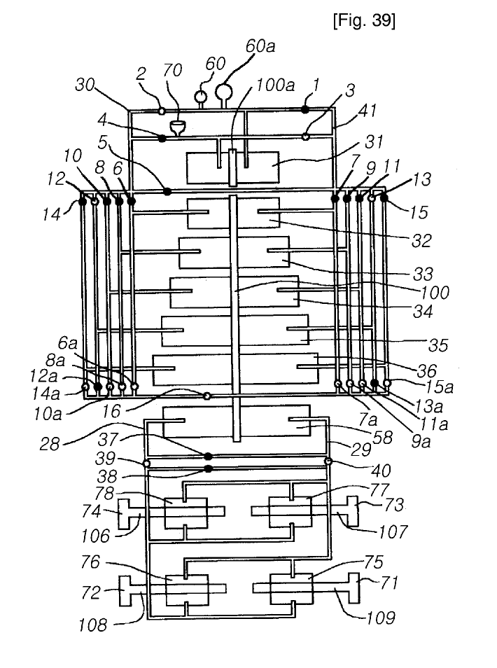

FIG. 39 is a schematic view showing a 4-wheel drive according to another embodiment of the present invention in a fourth forward stage. At this time, the liquid selection valves 2, 3, 12, 13, 16, 6a-11a, 14a, 15a, 39, 40 are opened and the liquid selection valves 1, 4, 5, 6-11, 14, 15, 12a, 13a, 37, 38 are closed.

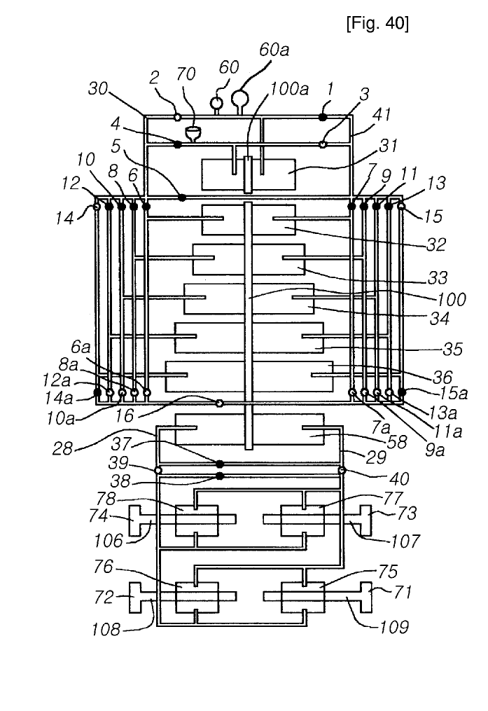

FIG. 40 is a schematic view showing a 4-wheel drive according to another embodiment of the present invention in a fifth forward stage. At this time, the liquid selection valves 2, 3, 14, 15, 16, 6a-13a, 39, 40 are opened and the liquid selection valves 1, 4, 5, 6-13, 14a, 15a, 37, 38 are closed.

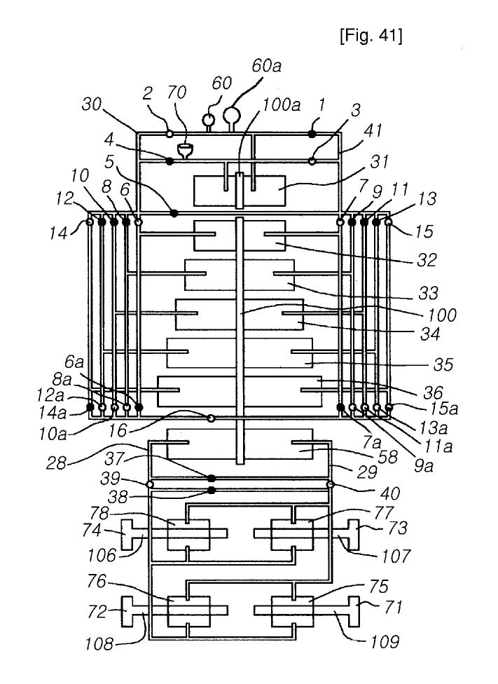

FIG. 41 is a schematic view showing a 4-wheel drive according to another embodiment of the present invention in a sixth forward stage. At this time, the liquid selection valves 2, 3, 6, 7, 14-16, 8a-13a, 39, 40 are opened and the liquid selection valves 1, 4, 5, 8-13, 6a, 7a, 14a, 15a, 37, 38 are closed.

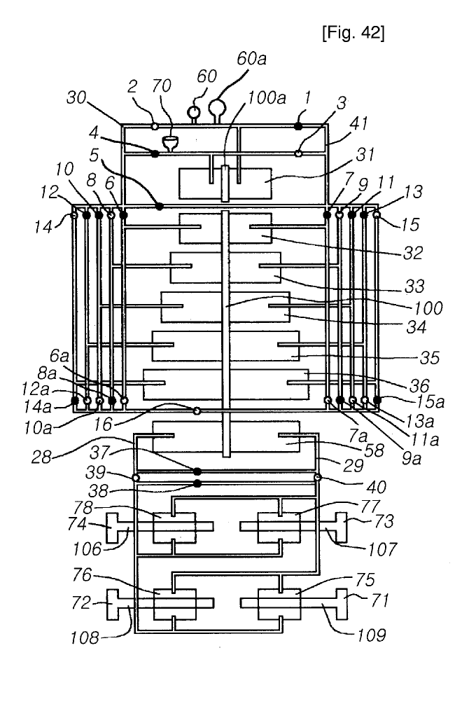

FIG. 42 is a schematic view showing a 4-wheel drive according to another embodiment of the present invention in a seventh forward stage. At this time, the liquid selection valves 2, 3, 8, 9, 14-16, 6a, 7a, 10a-13a, 39, 40 are opened and the liquid selection valves 1, 4, 5, 6, 7, 10-13, 8a, 9a, 14a, 15a, 37, 38 are closed.

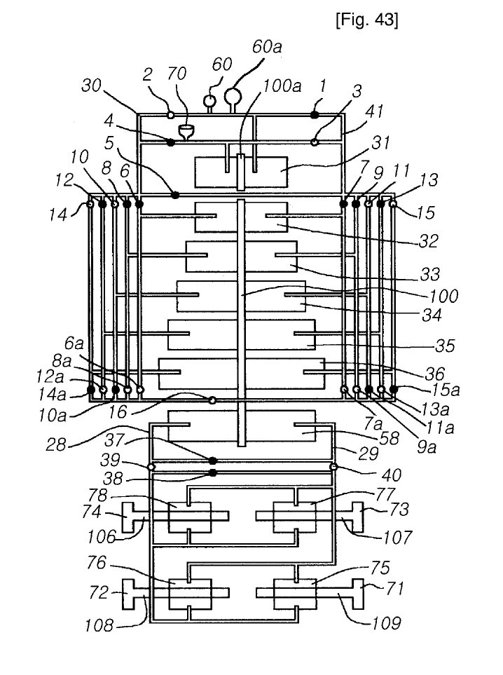

FIG. 43 is a schematic view showing a 4-wheel drive according to another embodiment of the present invention in a eighth forward stage. At this time, the liquid selection valves 2, 3, 10, 11, 14, 15, 16, 6a-9a, 12a, 13a, 39, 40 are opened and the liquid selection valves 1, 4, 5, 6-9, 12, 13, 10a, 11a, 14a, 15a, 37, 38 are closed.

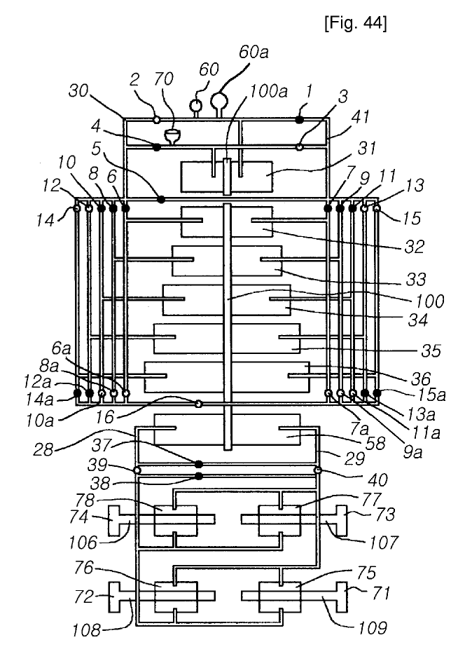

FIG. 44 is a schematic view showing a 4-wheel drive according to another embodiment of the present invention in a ninth forward stage. At this time, the liquid selection valves 2, 3, 12-16, 6a-11a, 39, 40 are opened and the liquid selection valves 1, 4, 5, 6-11, 12a-15a, 37, 38 are closed.

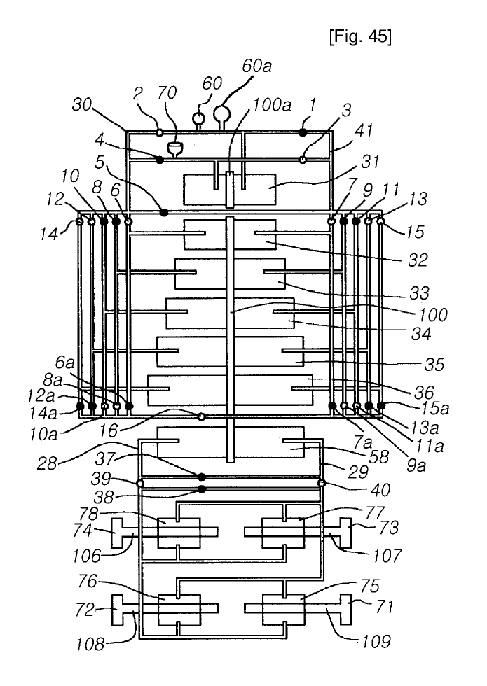

FIG. 45 is a schematic view showing a 4-wheel drive according to another embodiment of the present invention in a tenth forward stage. At this time, the liquid selection valves 2, 3, 6, 7, 12-15, 8a-11a, 16, 39, 40 are opened and the liquid selection valves 1, 4, 5, 8-11, 6a, 7a, 12a-15a, 37, 38 are closed.

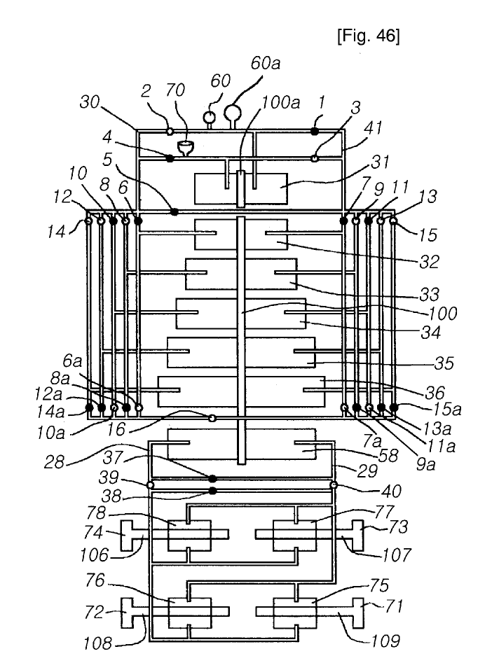

FIG. 46 is a schematic view showing a 4-wheel drive according to another embodiment of the present invention in a eleventh forward stage. At this time, the liquid selection valves 2, 3, 8, 9, 12-16, 6a, 7a, 10a, 11a, 39, 40 are opened and the liquid selection valves 1, 4, 5, 6, 7, 10, 11, 8a, 9a, 12a-15a, 37, 38 are closed.

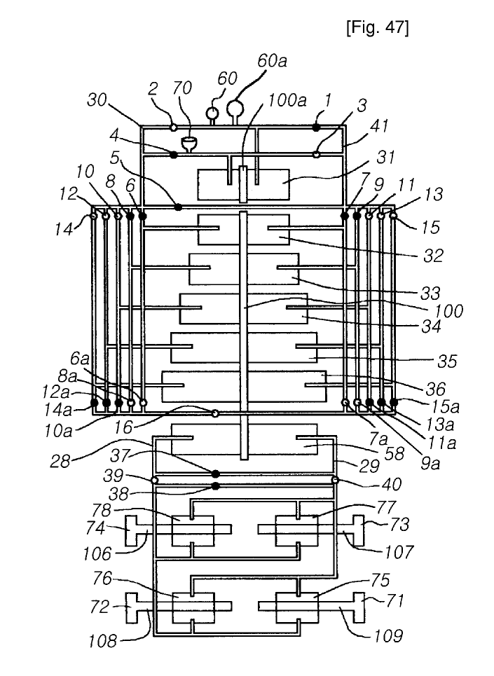

FIG. 47 is a schematic view showing a 4-wheel drive according to another embodiment of the present invention in a twelfth forward stage. At this time, the liquid selection valves 2, 3, 10-16, 6a-9a, 39, 40 are opened and the liquid selection valves 1, 4, 5, 6-9, 10a-15a, 37, 38 are closed.

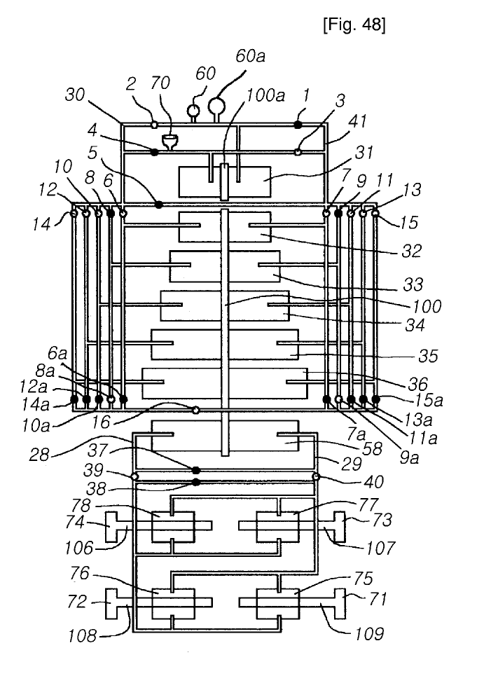

FIG. 48 is a schematic view showing a 4-wheel drive according to another embodiment of the present invention in a thirteenth forward stage. At this time, the liquid selection valves 2, 3, 6, 7, 10-16, 8a, 9a, 39, 40 are opened and the liquid selection valves 1, 4, 5, 8, 9, 6a, 7a, 10a-15a, 37, 38 are closed.

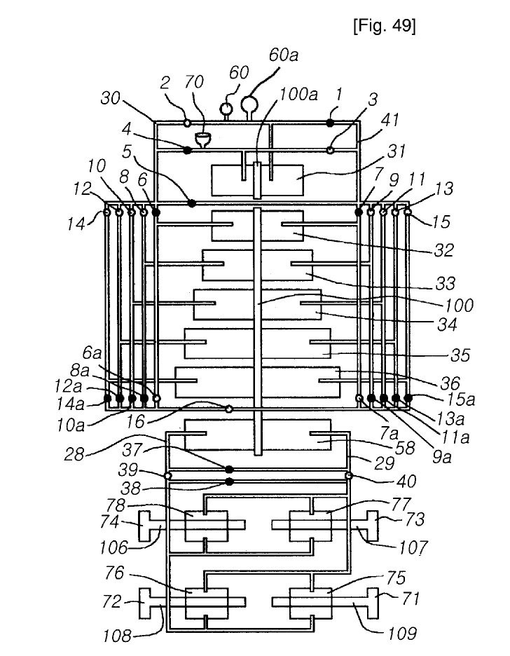

FIG. 49 is a schematic view showing a 4-wheel drive according to another embodiment of the present invention in a fourteenth forward stage. At this time, the liquid selection valves 2, 3, 8-16, 6a, 7a, 39, 40 are opened and the liquid selection valves 1, 4-7, 8a-15a, 37, 38 are closed.

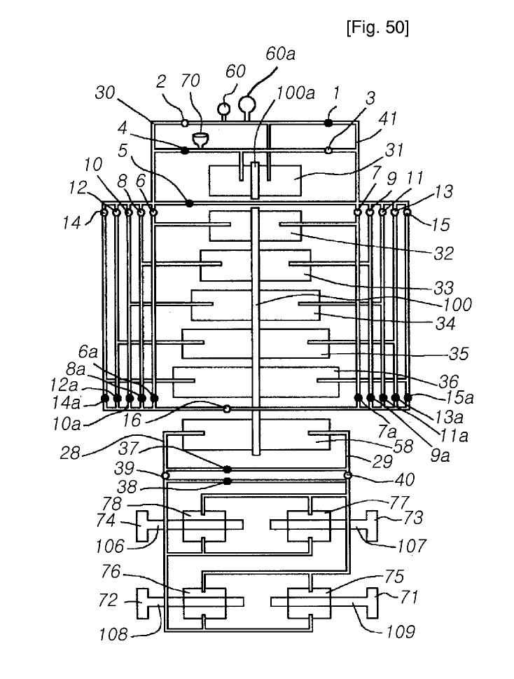

FIG. 50 is a schematic view showing a 4-wheel drive according to another embodiment of the present invention in a fifteenth forward stage. At this time, the liquid selection valves 2, 3, 6-16, 39, 40 are opened and the liquid selection valves 1, 4, 5, 6a-15a, 37 38 are closed.

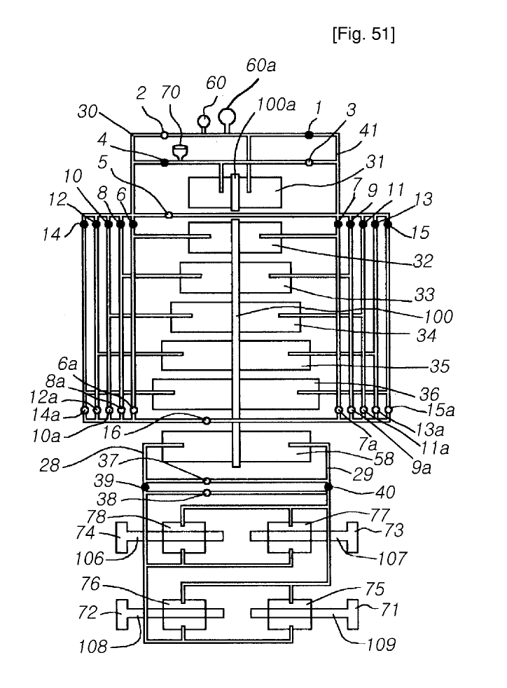

FIG. 51 is a schematic view showing a 4-wheel drive according to another embodiment of the present invention when a brake is in operation during running. At this time, the liquid selection valves 2, 3, 5, 16, 6a-15a, 37, 38 are opened and the liquid selection valves 1, 4, 5, 6-15, 39, 40 are closed.

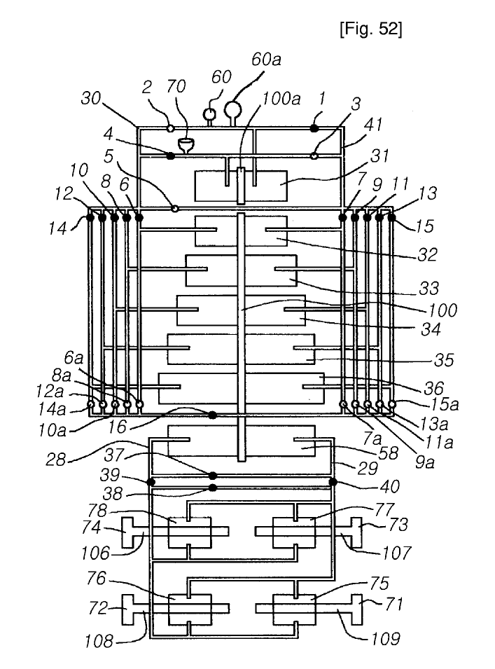

FIG. 52 is a schematic view showing a 4-wheel drive according to another embodiment of the present invention in an idle state during rearward running. At this time, the liquid selection valves 1, 4, 5, 6a-15a are opened and the liquid selection valves 2, 3, 6-16, 37-40 are closed.

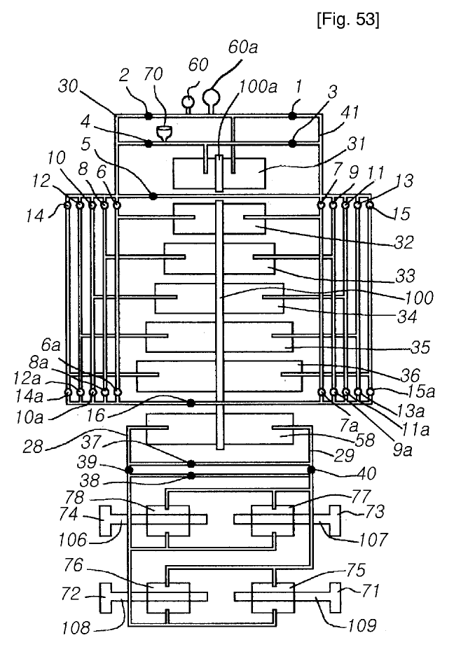

FIG. 53 is a schematic view showing a 4-wheel drive according to another embodiment of the present invention when an engine stops for stoppage or parking. At this time, the liquid selection valves 6-15, 6a-15a are opened and the liquid selection valves 1-5, 16, 37-40 are closed.

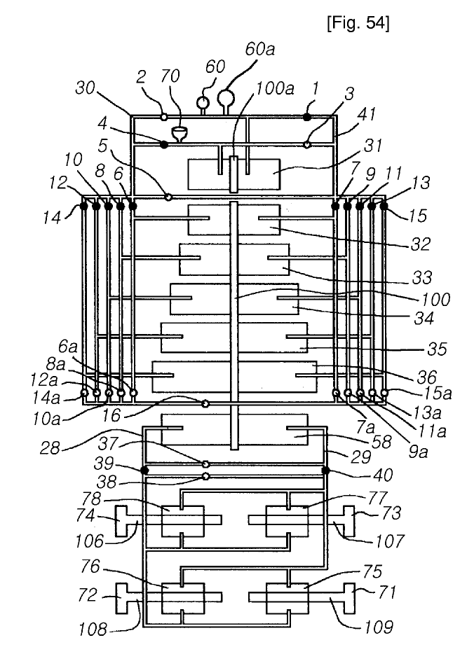

FIG. 54 is a schematic view showing a 4-wheel drive according to another embodiment of the present invention in a neutral state. At this time, the liquid selection valves 2, 3, 5, 16, 6a-15a, 37, 38 are opened and the liquid selection valves 1, 4, 6-15, 39, 40 are closed.

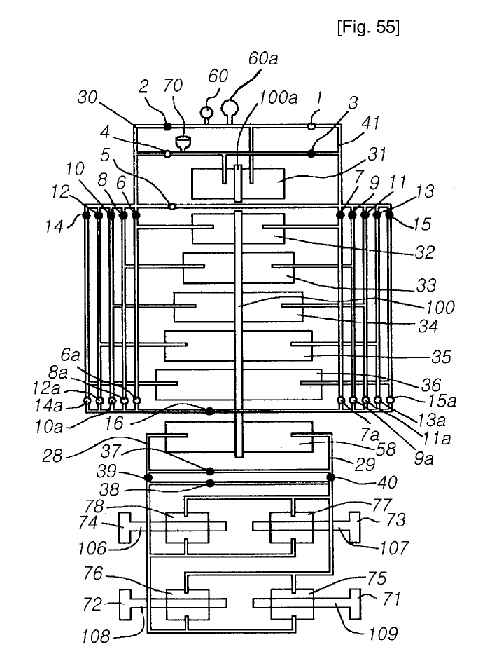

FIG. 55 is a schematic view showing a 4-wheel drive according to another embodiment of the present invention when a rearward running selection button is selected. At this time, the liquid selection valves 1, 4, 5, 6a-15a are opened and the liquid selection valves 2, 3, 6-16, 37-40 are closed.

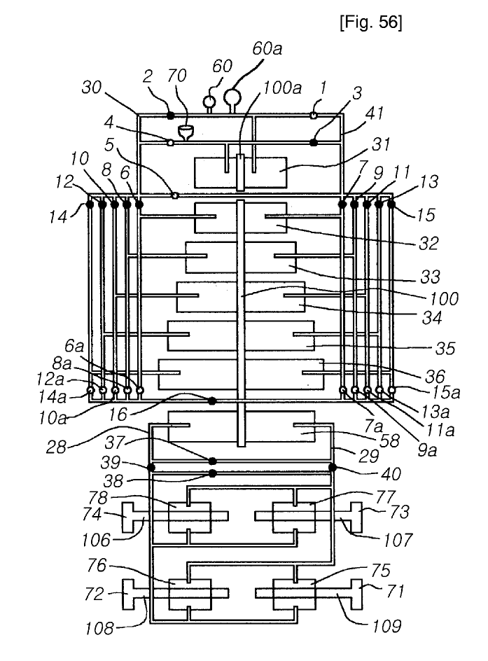

FIG. 56 is a schematic view showing a 4-wheel drive according to another embodiment of the present invention in a neutral state during running. At this time, the liquid selection valves 2, 3, 5, 16, 6a-15a, 37, 38 are opened and the liquid selection valves 1, 4, 6-15, 39, 40 are closed.

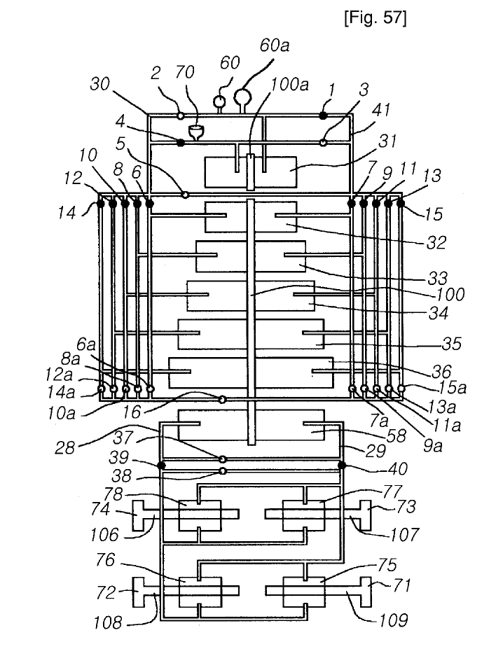

FIG. 57 is a schematic view showing a 4-wheel drive according to another embodiment of the present invention in a high-stage transmission neutral state during running. At this time, the liquid selection valves 2, 3, 5, 16, 6a-15a, 37, 38 are opened and the liquid selection valves 1, 4, 6-15, 39, 40 are closed.

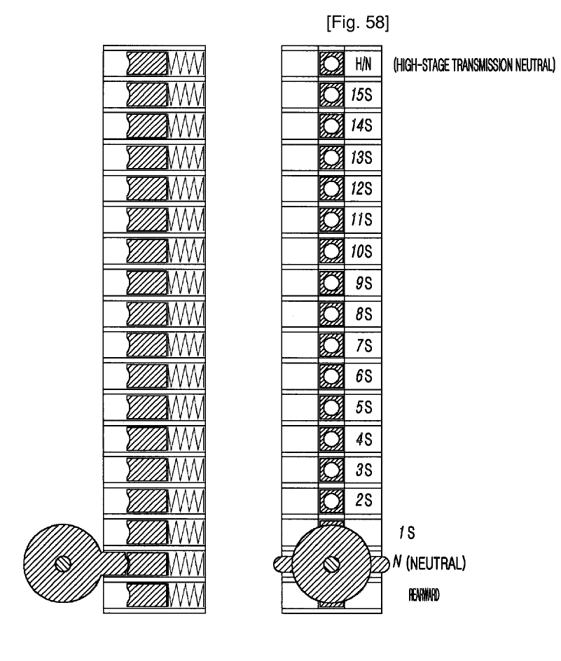

FIG. 58 is a side and front view showing a transmission control panel whose transmission lever is in a neutral position according to the present invention. At this time, the liquid selection valves 2, 3, 5, 16, 6a-15a, 37, 38 are opened and the liquid selection valves 1, 4, 6-15, 39, 40 are closed.

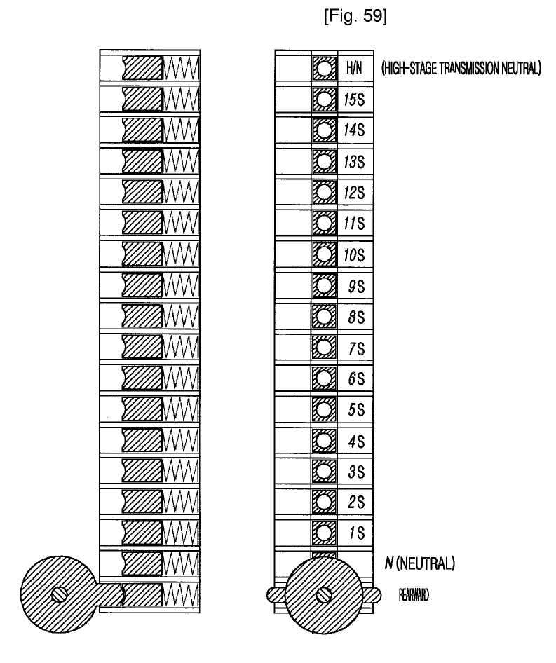

FIG. 59 is a side and plane view showing a transmission control panel whose transmission lever is in a rearward transmission position according to the present invention. At this time, the liquid selection valves 1, 4, 5, 6a-15a are opened and the liquid selection valves 2, 3, 6-16, 37-40 are closed.

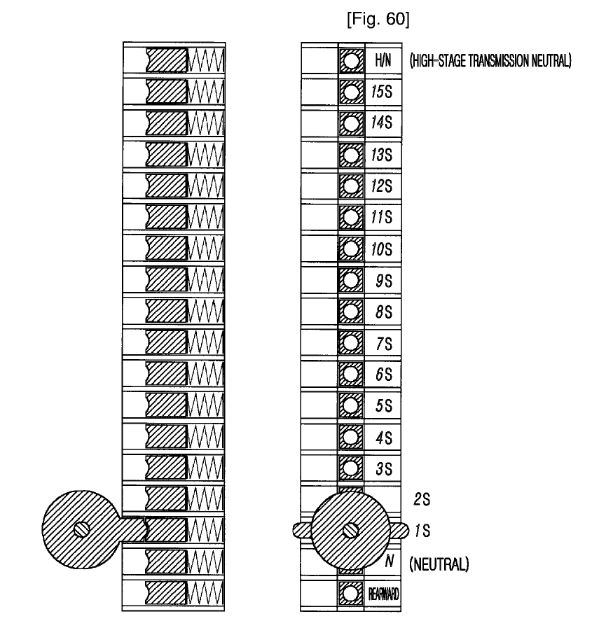

FIG. 60 is a side and plane view showing a transmission control panel whose transmission lever is in a first-stage transmission position according to the present invention. At this time, the liquid selection valves 2, 3, 6-15, 39, 40 are opened and the liquid selection valves 1, 4, 5, 16, 37, 38 are closed.

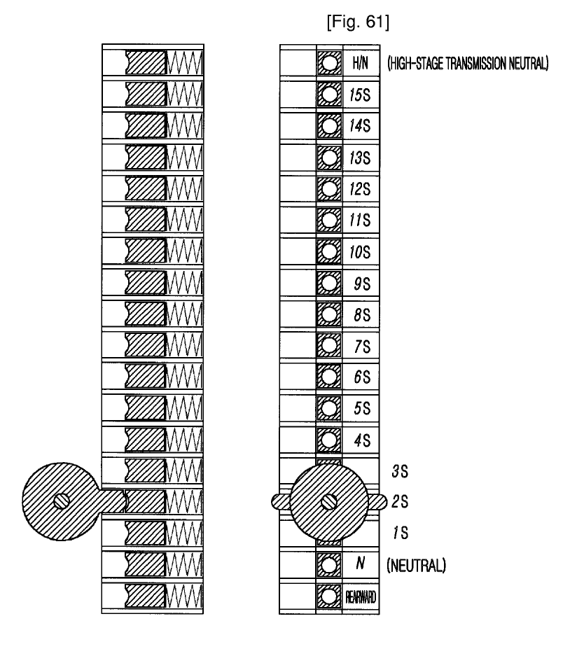

FIG. 61 is a side and plane view showing a transmission control panel whose transmission lever is in a second-stage transmission position according to the present invention. At this time, the liquid selection valves 2, 3, 8, 9, 16, 6a, 7a, 10a-15a, 39, 40 are opened and the liquid selection valves 1, 4, 5-7, 10-15, 8a, 9a, 37, 38 are closed.

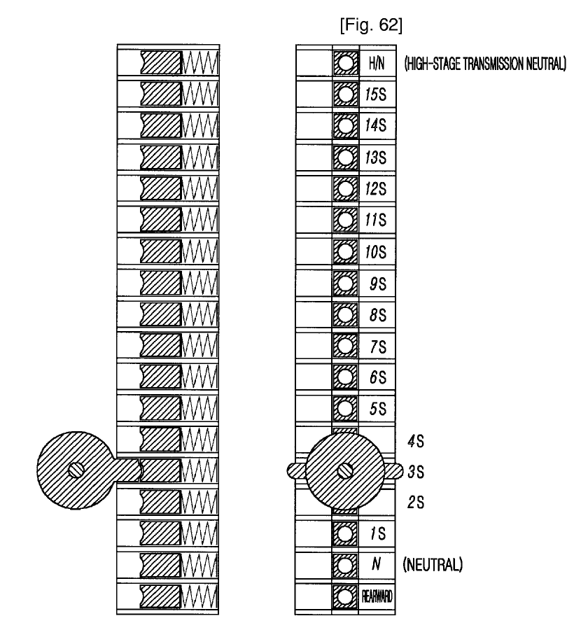

FIG. 62 is a side and plane view showing a transmission control panel whose transmission lever is in a third-stage transmission position according to the present invention. At this time, the liquid selection valves 2, 3, 16, 10, 11, 6a-9a, 12a-15a, 39, 40 are opened and the liquid selection valves 1, 4, 5, 6-9, 12-15, 10a, 11a, 37, 38 are closed.

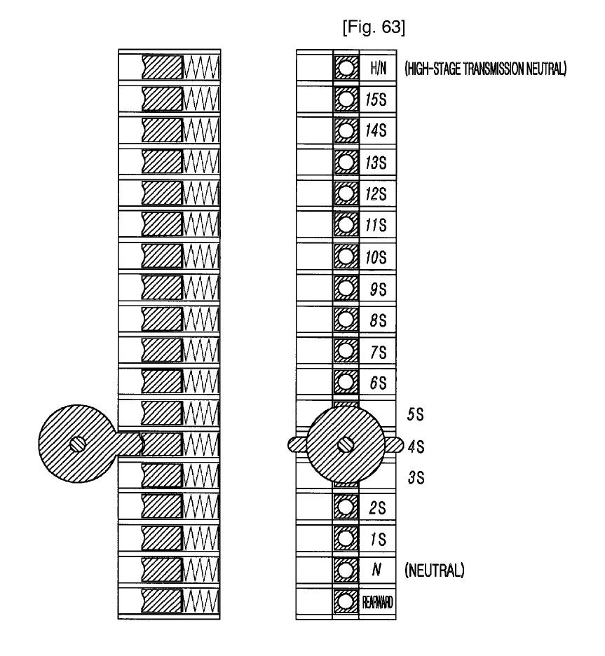

FIG. 63 is a side and plane view showing a transmission control panel whose transmission lever is in a fourth-stage transmission position according to the present invention. At this time, the liquid selection valves 2, 3, 12, 13, 16, 6a-11a, 14a, 15a, 39, 40 are opened and the liquid selection valves 1, 4, 5, 6-11, 14, 15, 12a, 13a, 37, 38 re closed.

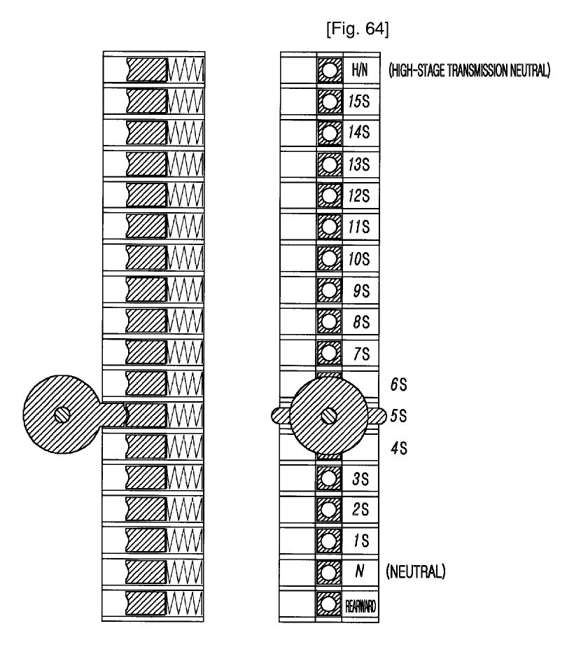

FIG. 64 is a side and plane view showing a transmission control panel whose transmission lever is in a fifth-stage transmission position according to the present invention. At this time, the liquid selection valves 2, 3, 14, 15, 16, 6a-13a, 39, 40 are opened and the liquid selection valves 1, 4, 5, 6-13, 14a, 15a, 37, 38 are closed.

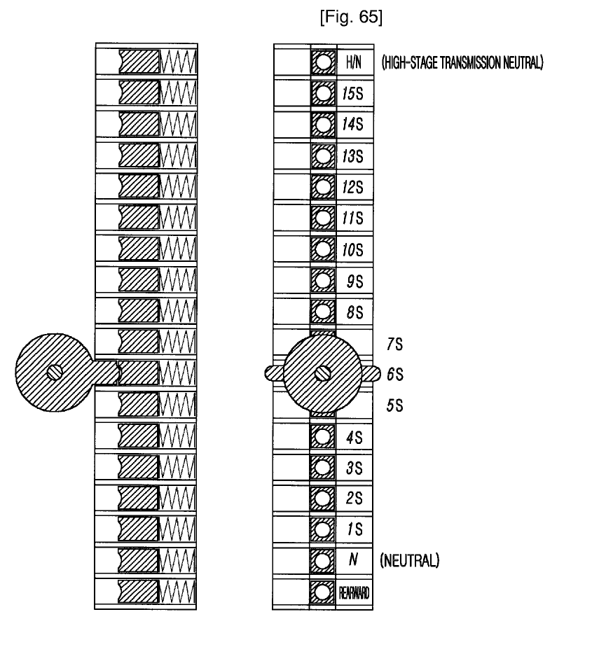

FIG. 65 is a side and plane view showing a transmission control panel whose transmission lever is in a sixth-stage transmission position according to the present invention. At this time, the liquid selection valves 2, 3, 6, 7, 14-16, 8a-13a, 39, 40 are opened and the liquid selection valves 1, 4, 5, 8-13, 6a, 7a, 14a, 15a, 37, 38 are closed.

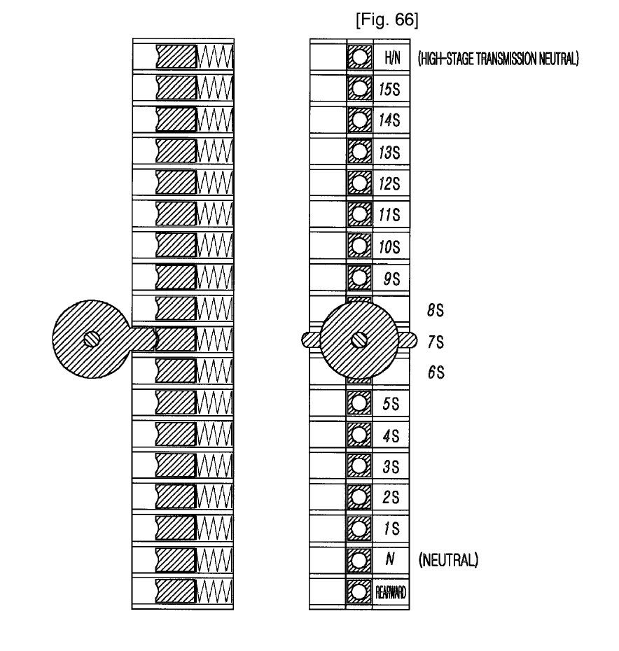

FIG. 66 is a side and plane view showing a transmission control panel whose transmission lever is in a seventh-stage transmission position according to the present invention. At this time, the liquid selection valves 2, 3, 8, 9, 14-16, 6a, 7a, 10a-13a, 39, 40 are opened and the liquid selection valves 1, 4, 5, 6, 7, 10-13, 8a, 9a, 14a, 15a, 37, 38 are closed.

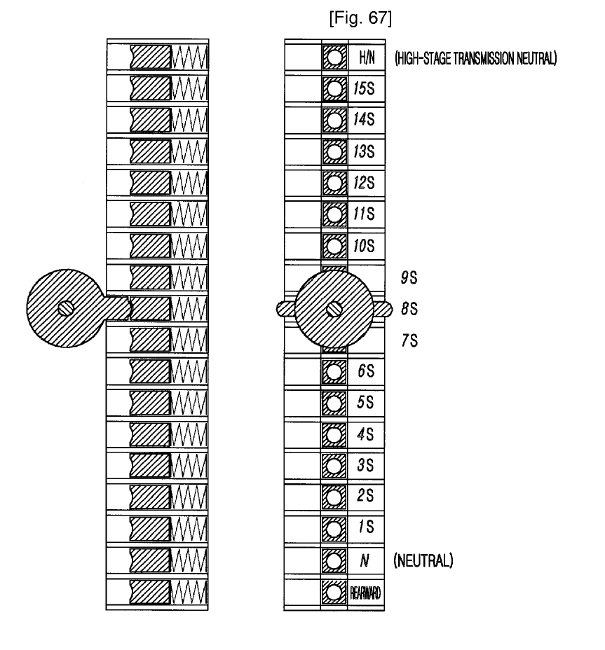

FIG. 67 is a side and plane view showing a transmission control panel whose transmission lever is in a eighth-stage transmission position according to the present invention. At this time, the liquid selection valves 2, 3, 10, 14, 15, 16, 6a-9a, 12a, 13a, 39, 40 are opened and the liquid selection valves 1, 4-9, 12, 13, 10a, 11a, 14a, 15a, 37, 38 are closed.

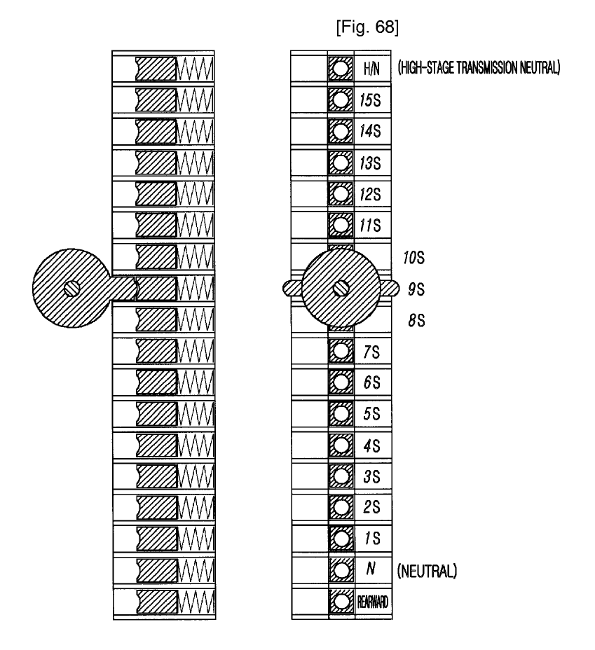

FIG. 68 is a side and plane view showing a transmission control panel whose transmission lever is in a ninth-stage transmission position according to the present invention. At this time, the liquid selection valves 2, 3, 12-16, 6a-11a, 39, 40 are opened and the liquid selection valves 1, 4, 5, 6-11, 12a-15a, 37, 38 are closed.

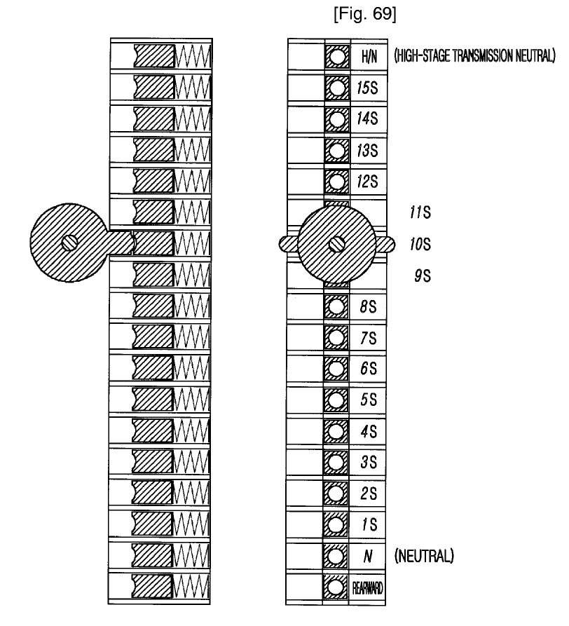

FIG. 69 is a side and plane view showing a transmission control panel whose transmission lever is in a tenth-stage transmission position according to the present invention. At this time, the liquid selection valves 2, 3, 6, 7, 12-16, 8a-11a, 39, 40 are opened and the liquid selection valves 1, 4, 5, 8-11, 6a, 7a, 12a-15a, 37, 38 are closed.

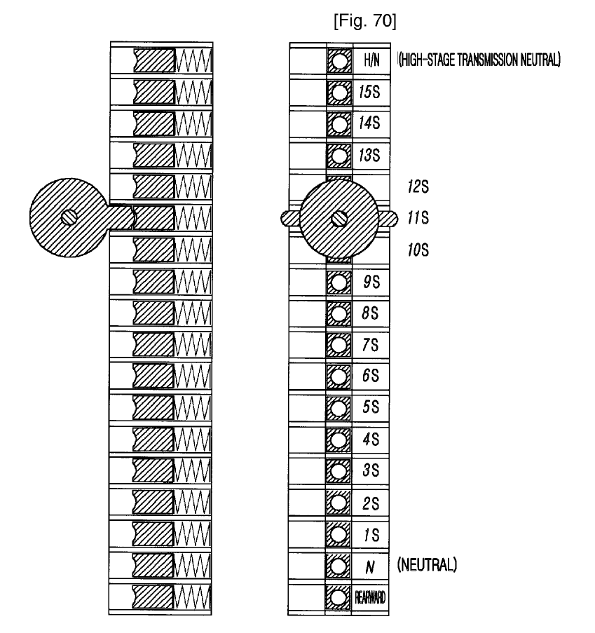

FIG. 70 is a side and plane view showing a transmission control panel whose transmission lever is in a eleventh-stage transmission position according to the present invention. At this time, the liquid selection valves 2, 3, 8, 9, 12-16, 6a, 7a, 10a, 11a, 39, 40 are opened and the liquid selection valves 1, 4, 5-7, 10, 11, 8a, 9a, 12a-15a, 37, 38 are closed.

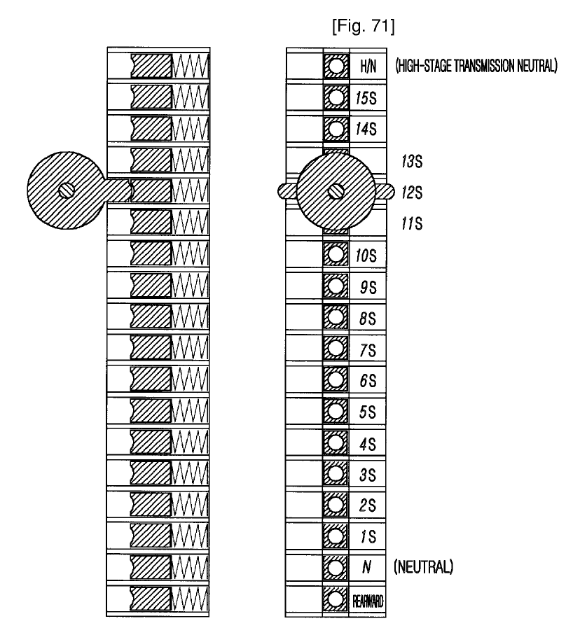

FIG. 71 is a side and plane view showing a transmission control panel whose transmission lever is in a twelfth-stage transmission position according to the present invention. At this time, the liquid selection valves 2, 3, 10-16, 6a-9a, 39, 40 are opened and the liquid selection valves 1, 4-9, 10a-15a, 37, 38 are closed.

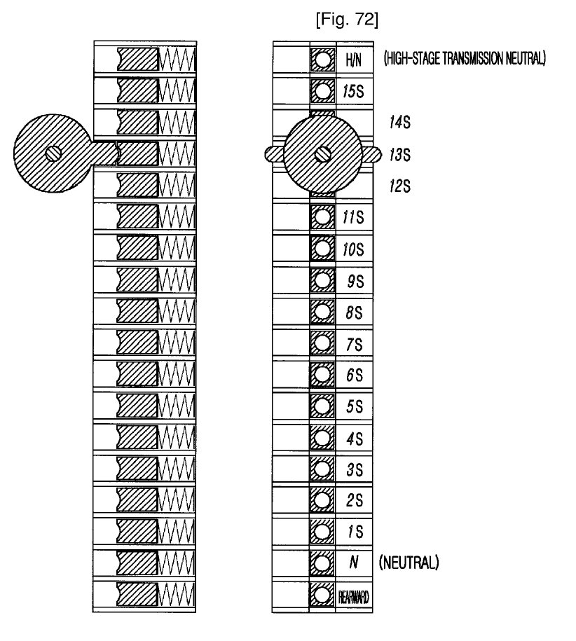

FIG. 72 is a side and plane view showing a transmission control panel whose transmission lever is in a thirteenth-stage transmission position according to the present invention. At this time, the liquid selection valves 2, 3, 6, 7, 10-16, 8a, 9a, 39, 40 are opened and the liquid selection valves 1, 4, 5, 8, 9, 6a, 7a, 10a-15a, 37, 38 are closed.

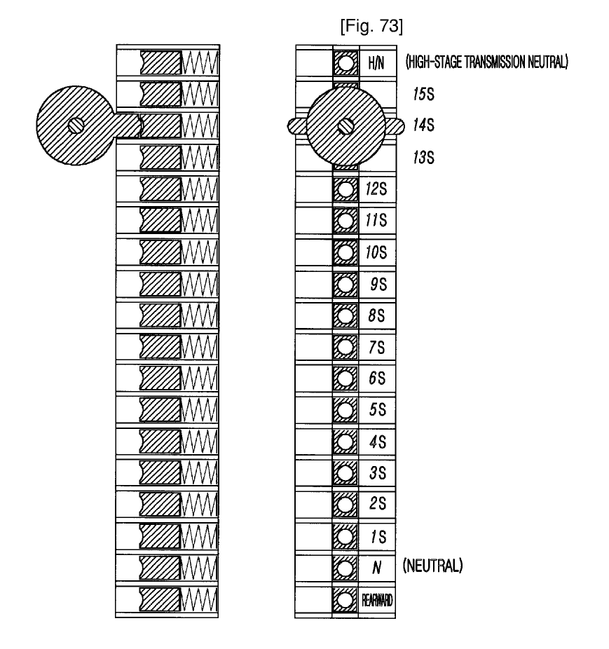

FIG. 73 is a side and plane view showing a transmission control panel whose transmission lever is in a fourteenth-stage transmission position according to the present invention. At this time, the liquid selection valves 2, 3, 8-16, 6a, 7a, 39, 40 are opened and the liquid selection valves 1, 4-7, 8a-15a, 37, 38 are closed.

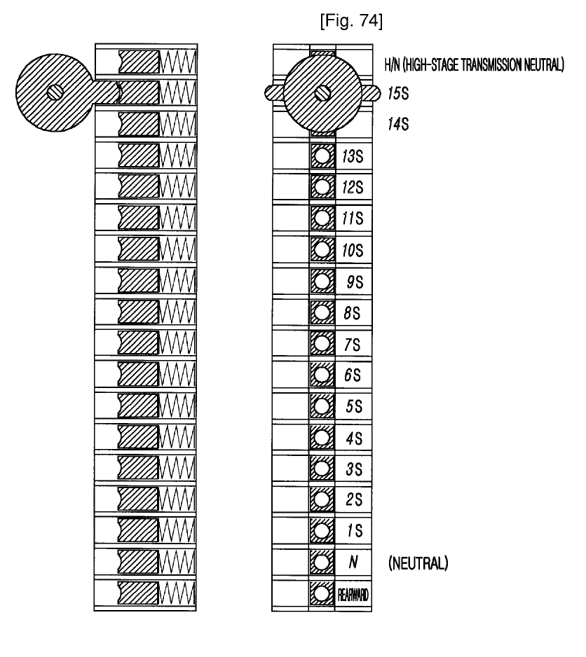

FIG. 74 is a side and plane view showing a transmission control panel whose transmission lever is in a fifteenth-stage transmission position according to the present invention. At this time, the liquid selection valves 2, 3, 6-16, 39, 40 are opened and the liquid selection valves 1, 4, 5, 6a-15a, 37, 38 are closed.

FIG. 75 is a side and plane view showing a transmission control panel whose transmission lever is in a high-stage transmission neutral position according to the present invention. At this time, the liquid selection valves 2, 3, 5, 16, 6a-15a, 37, 38 are opened and the liquid selection valves 1, 4, 6-15, 39, 40 are closed.

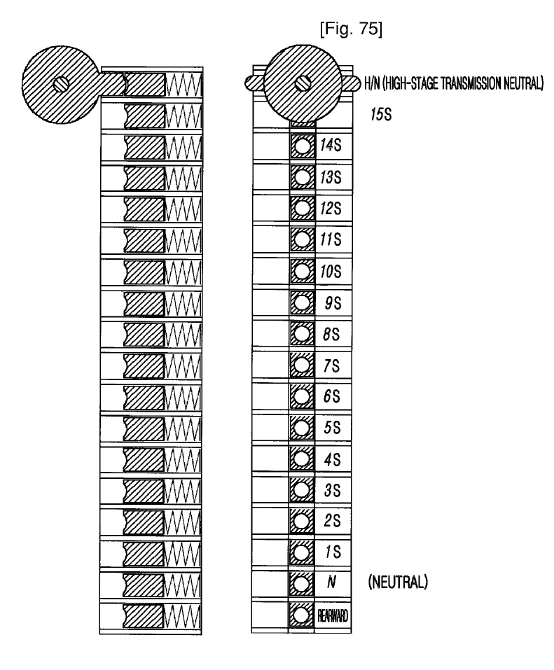

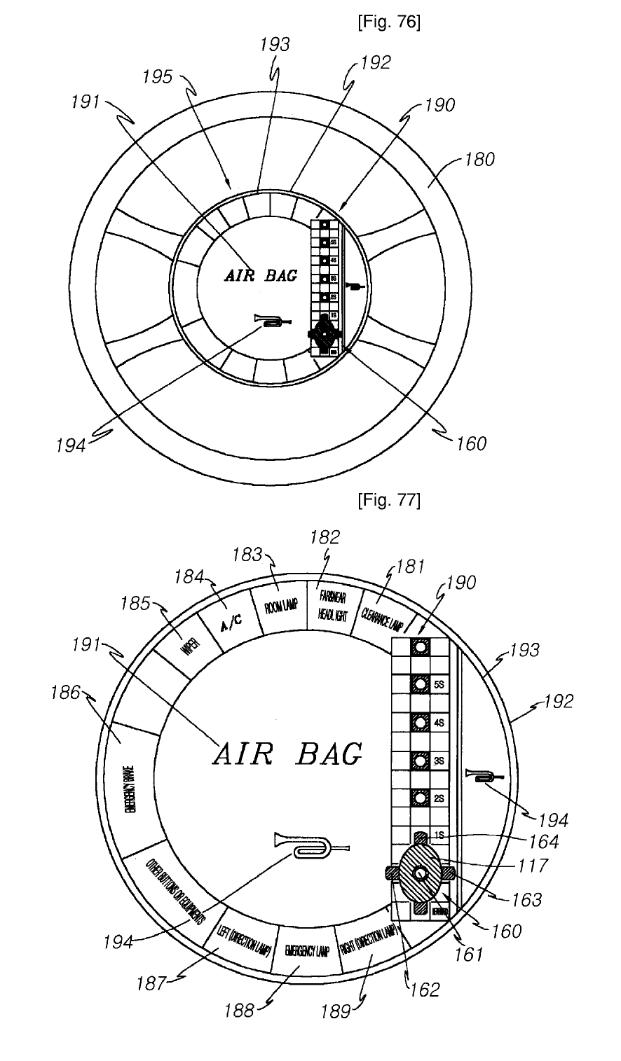

Meanwhile, in the present invention, as shown in FIG. 76, a center portion of a steering wheel 180 is fixed and the transmission control panel 190 is mounted to a right portion thereof. In addition, an air-bag 191 is mounted in the center portion, and a cap of the air-bag is used as a horn button 194. Moreover, on its outline, various buttons required for driving are installed for convenient use. This will be described below in more detail.

The center portion of the steering wheel 180 is fixed, and the transmission control panel 190 is mounted to the right of the center portion, thereby giving convenience to a driver to the maximum. In addition, the steering wheel 180 is integrated with an outer cylinder 192 at the center portion. Thus, if the steering wheel 180 is rotated, the outer cylinder 192 is also rotated to change a direction of the vehicle.

In addition, as shown in FIGS. 26 to 33, if a rearward running transmission cylindrical pillar 170 (or, an angular pillar) and a stick 166 of the transmission lever 160 are connected, electric current flows into the electronic control device to open or close the selection valves required for rearward running. If the stick 166 of the transmission lever 160 is connected to a neutral position, electric current flows into the electronic control device to open or close selection valves required for neutral.

If a first-stage transmission cylindrical pillar 172 (or, an angular pillar) is connected to the stick 166 of the transmission lever 160, electric current flows into the electronic control device to open or close selection valves required for first-stage transmission, and if a second-stage transmission cylindrical pillar 173 (or, an angular pillar) is connected to the stick 166 of the transmission lever 160, electric current flows into the electronic control device to open or close selection valves required for second-stage transmission, and if a second-stage transmission cylindrical pillar 173 (or, an angular pillar) is connected to the stick 166 of the transmission lever 160, electric current flows into the electronic control device to open or close selection valves required for second-stage transmission, and if a third-stage transmission cylindrical pillar 174 (or, an angular pillar) is connected to the stick 166 of the transmission lever 160, electric current flows into the electronic control device to open or close selection valves required for third-stage transmission, and if a fourth-stage transmission cylindrical pillar 175 (or, an angular pillar) is connected to the stick 166 of the transmission lever 160, electric current flows into the electronic control device to open or close selection valves required for fourth-stage transmission, and if a fifth-stage transmission cylindrical pillar 176 (or, an angular pillar) is connected to the stick 166 of the transmission lever 160, electric current flows into the electronic control device to open or close selection valves required for fifth-stage transmission.

If a high-stage transmission neutral cylindrical pillar 177 (or, an angular pillar) is connected to the stick 166 of the transmission lever 160, electric current flows into the electronic control device to open or close selection valves required for high-stage neutral transmission.

FIG. 77 is an expanded view showing the transmission control panel 190 mounted to the center portion of the steering wheel 180, where various buttons, the air-bag mounted therein and the horn button mounted thereto are expressed.

Now, the center portion of the steering wheel 180 as shown in FIG. 77 will be described.

The steering wheel 180 is integrated with the outer cylinder 192 to which the steering wheel 180 is fixed. Thus, if the steering wheel 180 is rotated, the outer cylinder 192 is also rotated to change a direction of vehicle. On the outline of the center portion, various buttons for horn, clearance lamp, head light, room lamp, air conditioner, wipers, turn signal lamp, emergency brake and so on are provided for convenient use.

Here, the emergency brake will be described in more detail.

The present invention includes an emergency brake system for facilitating safe driving. If a brake pedal is stepped to contact with the bottom at breakage or malfunction, an emergency brake button installed on the bottom of the brake pedal is pressed. In other case, an emergency brake button 186 installed on the outline of the center portion of the steering wheel 180 is pressed. Then, the selection valves 2, 3, 5, 8-16, 37, 38 are opened and the other selection valves are all closed so that the transmission acts as a brake to stop the vehicle, which allows a user to drive the vehicle in a safer way.

In addition, a brake pipe is doubly mounted in the present invention, so, if either of them is broken down, the electronic control device senses it and then closes the valves previously installed to the proximal and distal portions of the broken pipe. Then, the other pipe not broken down still allows the transmission to give a function of brake.

Meanwhile, in the present invention, as shown in FIG. 81, when the brake pedal 510 is stepped down, a master cylinder 500 is operated to drive the brake device 520. At this time, if the brake pedal 510 is released, the master cylinder 500 does not drive the brake device 520 to be released, so the vehicle may be pushed down on a slope. Thus, in the present invention, a liquid pressing device 530 is installed in parallel to the master cylinder 500 so that a liquid pressing device 530 operates the master cylinder 500 to drive the brake device 520. Thus, the vehicle is not pushed on a slope and may start easily thereon.

The liquid pressing device 530 of the present invention is controlled by the electronic control device 540. The electronic control device 540 senses a rotational speed of the vehicle engine, a stepped degree of the brake pedal 510, stoppage and starting of the vehicle and so on, and then allows the liquid pressing device 530 to drive the master cylinder 500. If the vehicle is not moving and the engine is operating, the liquid pressing device 530 is operated to drive the brake, and the brake is released from the point that the rotational speed of the engine starts increasing from the minimum speed.

However, at starting the vehicle, though the rotational speed of the engine is increased, the brake is not released, while the brake is released if the rotational speed of the engine is increased after the engine encompasses its minimum rotational speed.

Thus, when a vehicle starts on a slope after stoppage, the brake is under operation since the engine is in a minimum rotating state, while, after the accelerator pedal is stepped down, the vehicle starts moving with the brake released since the rotational speed of the engine is increased. Accordingly, the vehicle may start moving without being slid back.

Meanwhile, the air-bag is mounted in the left of the center portion of the steering wheel 180, and its cap is used as a horn button. In addition, the transmission control panel 190 is mounted to the right of the center portion so that the transmission control panel 190 may be moved in a convenient and easy way to shift gears.

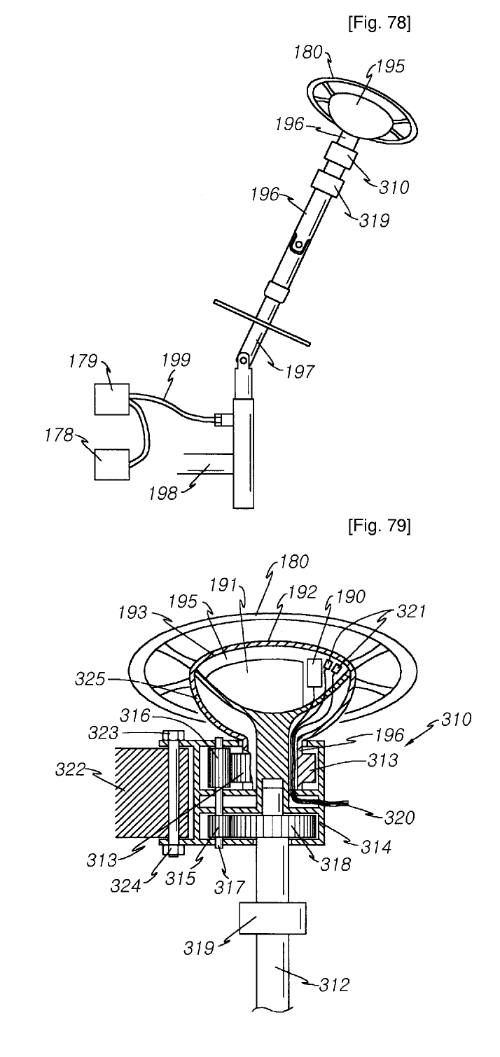

As shown in FIG. 78, the steering device is composed in the order of the steering wheel 180, a center portion 195 of the steering wheel, a steering shaft 196, a gear unit 310 of the steering shaft, and a steering column 319. In steering, the rotation of the steering wheel 180 is transmitted to the front wheels via the gear unit 310 of the steering shaft in the above order, thereby steering the vehicle.

In the present invention, as shown in FIG. 79, when the steering wheel 180 is turned to change a direction of the vehicle, the steering shaft 196 positioned on the extension line of the outer cylinder 192 to which the steering wheel 180 is fixed is rotated, and thus a gear 313 installed to the steering shaft 196 is rotated, also rotating a gear 316 engaged with the gear 313, thereby rotating a gear 315 engaged with the gear 316, thereby rotating a gear 318 engaged with the gear 315, resultantly rotating a steering shaft 312 fixed to the gear 318 so that front wheels are steered to change an advancing direction of the vehicle.

At this time, an inner cylinder 193 adjacent to the outer cylinder 192 to which the steering wheel 180 is fixed is integrally connected to an inner cylindrical pillar 311. This inner cylindrical pillar 311 is integrally connected to a case 314. This case 314 is firmly fixed to a vehicle body 322.

Since the case 314 is fixed to the vehicle body 322, the inner cylindrical pillar 311 does not rotate, and accordingly the inner cylinder 311 is not rotated. Thus, the center portion 195 of the steering wheel 180 is fixed as mentioned above.

Thus, on the center portion 195 of the steering wheel 180, the air-bag 191, the horn button 194, various buttons 181-189 and other necessary buttons may be installed in addition to the transmission control panel 190. In addition, other important equipments may also be mounted thereto.

By using the above configuration, a user may shift gears in a rapid and convenient way and manipulate equipments attached thereto while the vehicle is running, thereby ensuring safer driving.

On occasions, all switches mounted in the steering column 319 may be moved to the center portion 195 of the steering wheel 180. In this case, the steering column 319 may not be installed to the steering shaft 312.

However, if the steering column 319 is still required due to the habit of drivers, the steering column 319 is installed to the steering shaft 312, and the same switches are doubly installed to the center portion 195 of the steering wheel 180.

In addition, wires 320 connected to various equipments and buttons installed on the center portion 195 of the steering wheel are connected to the power source together with the electronic control device via a passage 325 between the outer cylinder 192 and the inner cylinder 193.

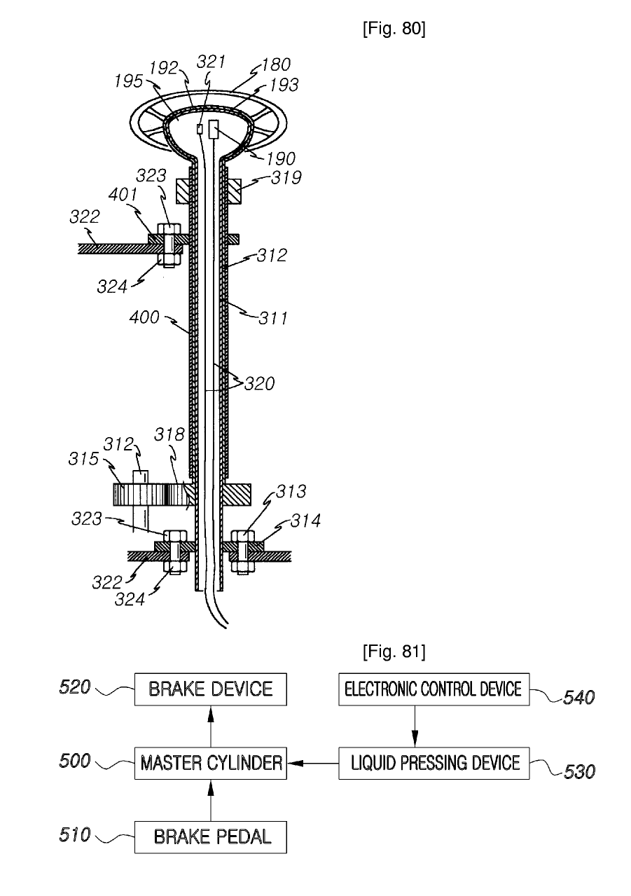

As shown in FIG. 80, when the steering wheel 180 is rotated for steering, namely for changing a direction of vehicle, the outer cylinder 192 fixed to the steering wheel 180 is rotated, thus rotating a gear 318 mounted to the distal portion of the outer cylinder 192, thereby rotating a gear 315 connected thereto, thereby rotating the steering shaft 312 fixed thereto, thereby steering the front wheels to change a running direction of the vehicle.

At this time, the inner cylinder 193 adjacent to the steering wheel 180 is integrally connected to the inner cylindrical pillar 311, and the inner cylindrical pillar 311 is fixed to the vehicle body 322 via a plate 401 installed thereto by using bolts 323 and nuts 324 so that the inner cylindrical pillar 311 may not rotate.

By using such configuration, the center portion 195 of the steering wheel is fixed not to rotate.

In addition, the wires 320 of electric equipments installed to the center portion 195 of the steering wheel are guided out through the inside of the inner cylindrical pillar 311, and then connected to the electronic control device and the power source, not shown.

In addition, an outermost cylinder 400 is covered to protect the steering shaft 312.

By using such configuration, the plate 401 provided above the outermost cylinder 400 is fixed to the vehicle body 322 by bolts 323 and nuts 324 so as to fix the steering wheel 180 and the steering shaft 312 not to move.

As mentioned above, the present invention opens and closes the selection valves as required for desired gear shifting to make forward or rearward running or each stage transmission, as illustrated in FIGS. 1 to 10. At this time, as the number of operating hydraulic rotary machines 32-36 is decreased, the driving force of the main shaft 100 is deteriorated and the rotational speed is increased rather than the case that all hydraulic rotary machines 32-36 are operating.

In addition, since the present invention presses liquid to a high pressure and moves it in pipes, heat is generated while the liquid is moving. The heat generated at this time should be preferably lowered by means of air-cooling, but if much heat is generated, water-cooling is preferably used to lower the temperature of liquid.

In addition, when the transmission control panel 190 is to be moved to a neutral state, the present invention closes the selection valves 1, 4, 6, 7 and opens all of the other valves.

Thus, if load of vehicle is decreased on a declined slope or due to inertia of the vehicle due to the above phenomenon, hydraulic pressure in the pipe 30 is decreased. If the hydraulic pressure in the transmission control oil pressure gauge 60 is decreased accordingly, the moving body 61 moves down to connect the contact points 62 at both sides, so the transmission lever 160 is moved to a high-stage transmission position by the electronic control device.

Therefore, if the hydraulic pressure in the transmission control oil pressure gauge 60 is still low and the moving body 61 keeps connecting the contact points 62 though the transmission lever 160 is moved to the highest-stage transmission position, the electronic control device moves the transmission lever 160 to a high-stage transmission neutral position.

If the transmission lever 160 is moved to a high-stage transmission neutral position, the transmission is automatically shifted to a high-stage transmission neutral state by the electronic control device, closing the selection valves 1, 4, 6, 7 and opening all of the other valves.

Meanwhile, if hydraulic pressure in the transmission control oil pressure gauge 60 is increased and the moving body 61 moves up to the contact points 63, the contact points 63 are connected to each other and the electronic control device moves the transmission lever 160 to a low-stage transmission position.

By means of the above functions, in case the vehicle is running fast and the transmission is in a high-stage transmission neutral state, if the engine rotates at a lowest speed without the accelerator stepped, fuel consumption becomes reduced.

In addition, if the neutral button 163 installed to the transmission lever 160 is pressed, the neutral state is initiated in any transmission state. At this time, the selection valves 1, 4, 6, 7, 39, 40 are closed and the other selection valves are all opened. If the neutral button 163 is pressed once more, the button returns to its original condition and the initial state is released as before the neutral valve 163 is pressed.

Meanwhile, in case that the brake is stepped during running to stop the vehicle, as shown in FIG. 8, the selection valves 2, 3, 5, 8-16, 37, 38 are opened and the selection valves 1, 4, 6, 7, 39, 40 are closed so that the liquid pressed by the rotary pumps 31, 58 is not flowed into the hydraulic rotary machines 32-36, 75-78. In case that the vehicle does not stop but keeps running when the brake is stepped, the hydraulic rotary machines 32-36, 75-78 becomes idle due to the running so that rotating power is not transmitted to the shaft 100 when the brake is stepped, thereby reducing a distance required for stopping.

Meanwhile, the present invention makes a vehicle running by installing the hydraulic rotary machines to each of front and rear wheels. Thus, if the front and rear wheels are driven using the hydraulic rotary machines, there is no need of using a differential gear, thereby simplifying structure and not generating any noise when gears are shifted.

In addition, the rotary pump employed in the present invention may be used as a water pump, a water supplier, an oil supplier, an air blower and so on, and the hydraulic rotary machine may be used as a water power rotating machine instead of a water wheel for a water power plant as well as a gas power rotating machine instead of a gas turbine for a gas power plant. Moreover, the principle of the rotary pump may be applied in manufacturing a rotary engine that is an internal combustion engine.

### INDUSTRIAL APPLICABILITY

The present invention connects the hydraulic rotary machines to the shaft of a vehicle in parallel and then selects flow of the pressed liquid introduced to the hydraulic rotary machines by using the selection valves so that gears are shifted according to a running load, wherein 4-wheel driving capable of automatic and manual transmission is enabled, a neutral state may be obtained in any event during running, automatic and manual manipulation is possible by means of a simple structure using the hydraulic rotary machines and the selection valves, reliable power transmission is ensured with a simple structure, and breakdown and costs are reduced.

In addition, the present invention fixes the center portion of the steering wheel not to rotate and installs the transmission control panel thereto so that the transmission lever may be instantly moved front and rear in a very convenient and easy way to shift gears.

In addition, the present invention is characterized in that various buttons such as a horn button, a near view head light button, a far view headlight button, a direction lamp button, an emergency lamp button, an air conditioner button, a wiper button, a clearance lamp button and an emergency brake button are installed to the outline of the fixed center portion of the steering wheel.

In addition, the present invention facilitates safe driving by providing the emergency brake system, wherein if a brake pedal is stepped to contact with the bottom at breakage or malfunction, an emergency brake button installed on the bottom of the brake pedal is pressed, or an emergency brake button installed on the outline of the center portion of the steering wheel is pressed so that the selection valves 2, 3, 5 are opened and the other selection valves are all closed to make the transmission act as a brake to stop the vehicle. In addition, since a brake pipe is doubly mounted in the present invention, if either of them is broken down, the electronic control device senses it and then closes the valves previously installed to the proximal and distal portions of the broken pipe, while the other pipe not broken down still allows the transmission to give a function of brake.

Meanwhile, the present invention installs the liquid pressing device 530 in parallel to the master cylinder 500 so that the liquid pressing device 530 operates the master cylinder 500 to drive the brake device 520, whereby the brake is in operation when the vehicle is stopped, but the brake is released front the instant that the vehicle starts being accelerated in a minimum rotating state.

In addition, the present invention is configured so that the brake is released when the rotational speed of the engine is increased after the engine encompasses its minimum rotational speed, whereby, when a vehicle starts on a slope after stoppage, the brake is under operation since the engine is in a minimum rotating state, while, after the accelerator pedal is stepped down, the vehicle starts moving with the brake released since the rotational speed of the engine is increased so that the vehicle may start moving without being slid back.

1. A 4-wheel drive of a hydraulic manual and automatic transmission, comprising: a rotary pump rotating a rotator eccentrically mounted in a cylinder by means of rotation of a shaft connected to a rotation power of a vehicle engine so that a perfect circular front end of a wing made of slide material and installed to a wing hole rotates an inner wall of a perfect circular cylinder in close contact to discharge a liquid from an inlet hole to an outlet hole by pressure; a hydraulic rotary machine receiving the liquid from the rotary pump through a pipe and having the same configuration as the rotary pump connected to a main shaft in parallel in multi stages; a rotary pump installed to the main shaft rotating by means of the hydraulic rotary machine to discharge liquid by means of the rotation of the main shaft by pressure; hydraulic rotary machines respectively installed to front and rear wheel shafts so as to receive the pressed liquid from the rotary pump through a pipe and rotate front and rear wheels; a pipe installed to recover a liquid pressed in the rotary pump via the hydraulic rotary machines; a plurality of liquid selection valves installed to the pipe in multi stages and regulating flow of the liquid introduced to the hydraulic rotary machine; a transmission control oil pressure gauge for sensing liquid pressure in the pipe; an impact damping chamber for absorbing impact wave generated during gear shifting, and a liquid container for controlling surplus and shortage of liquid; and an electronic control device for sensing liquid pressure of the transmission control oil pressure gauge or change of a transmission lever to control opening or closing of the liquid selection valves.

2. The 4-wheel drive of a hydraulic manual and automatic transmission according to claim 1, wherein the rotary pump is configured so that the eccentric rotator rotates the wing with being completely adhered to the inside of the cylinder to rotate the shaft, and wherein a space (A) is formed in an upper portion of the cylinder so that liquid is not compressed but discharged when the wing is rotating.

3. The 4-wheel drive of a hydraulic manual and automatic transmission according to claim 1, wherein the liquid discharged by the rotating rotator rotated by engine power rotates the multi-stage hydraulic rotary machine installed to the main shaft via the pipe so that the front and rear wheels are driven, wherein a rotary pump for 4-wheel drive is installed to a rear end of the main shaft, wherein the hydraulic rotary machines are installed to the front and rear wheel shafts to rotate the front and rear wheels, and the hydraulic rotary machines are rotated by means of liquid pressed by the rotary pump, and wherein, between the hydraulic rotary machines and the rotary pumps for driving the front and rear wheels, a pipe for supplying and recovering liquid and a liquid selection valve for regulating liquid flow by control of the electronic control device are installed.

4. The 4-wheel drive of a hydraulic manual and automatic transmission according to claim 1, wherein a moving body moves up and down in the pipe through which the liquid pressed by the rotary pump is flowing, by means of pressure of the liquid, wherein there is provided a transmission control oil pressure gauge installed for sensing position of the moving body by using a contact point, and wherein the electronic control device recognizes a sensing result of the transmission control oil pressure gauge and then regulates opening and closing of the liquid selection valves.

5. The 4-wheel drive of a hydraulic manual and automatic transmission according to claim 1, wherein the hydraulic rotary machines are independently installed to the front and rear wheels of a vehicle so that the front and rear wheels are independently rotated by means of the rotation of the hydraulic rotary machines without a dif-ferential gear.

6. The 4-wheel drive of a hydraulic manual and automatic transmission according to claim 1, wherein a transmission control panel for controlling gear shifting through the electronic control device capable of all gear shifting in an electronic way is fixed to a center portion of the steering wheel not to rotate, wherein a transmission lever installed to the transmission control panel is auto-matically or manually moved to shift gears, and wherein a switch button for manipulation is installed to an outer line of the center portion of the steering wheel.

7. The 4-wheel drive of a hydraulic manual and automatic transmission according to claim 1, wherein a brake pipe having liquid selection valves is doubly installed to proximal and distal portions, wherein an emergency brake button is installed to a brake pedal, a bottom and a center portion of the steering wheel so that a sudden stop is made when the emergency brake button is pressed, and wherein the electronic control device senses breakage of any brake pipe and then closes the liquid selection valves of the corresponding brake pipe.

8. The 4-wheel drive of a hydraulic manual and automatic transmission according to claim 1, wherein the rotary pump and the liquid rotary machine include rotator and wing acting as a cylinder and a piston, and a lining device elastically supported by a spring to the wing at both sides of the rotator that is rotated in close contact with the rotating wing to ensure high efficiency in introducing, compressing and discharging the liquid.

9. The 4-wheel drive of a hydraulic manual and automatic transmission according to claim 6, wherein the steering wheel includes: a center portion to which a fixed transmission control panel, a switch button and a safety air-bag are installed; a steering shaft gear unit for connecting the steering wheel and its rotation to a steering shaft; and a steering shaft for transmitting the rotation of the steering wheel to the front wheels via the steering shaft gear unit.

10. The 4-wheel drive of a hydraulic manual and automatic transmission according to claim 9, wherein an inner cylindrical pillar extended from the center portion of the steering wheel to which the transmission control panel, the plurality of switch buttons and the safety air-bag are installed is fixed to a bottom of a vehicle body, wherein wires connected to the transmission control panel and the switch buttons are guided to connect to the electronic control device via an inside of the inner cylindrical pillar, wherein an outer cylinder extended from the steering wheel is positioned around the inner cylindrical pillar and transmits rotation of the steering wheel to a steering shaft by means of gears mounted thereto, and wherein an outermost cylinder is positioned around the outer cylinder and fixed to the vehicle body.

11. The 4-wheel drive of a hydraulic manual and automatic transmission according to claim 1, wherein the rotary pump and the hydraulic rotary machine are configured so that the wings are coupled to a main shaft installed therein, wherein teeth are formed on the main shaft so that teeth grooves are formed in one wing is formed to be engaged with the teeth and the other wing is inserted to the teeth of the main shaft from outside to be freely rotatable.

12. The 4-wheel drive of a hydraulic manual and automatic transmission according to claim 1, wherein the rotary pump and the hydraulic rotary machine are configured so that the wings are coupled to a main shaft installed therein, wherein teeth are formed in an inner side of one wing ring to be engaged with teeth grooves formed on a surface of the main shaft and circular grooves are formed on the other wing ring to be engaged to the main shaft from outside to be free rotatable.

13. The 4-wheel drive of a hydraulic manual and automatic transmission according to claim 11, wherein two wings inserted to the main shaft in the cylinder are coupled to lower portions of inlet and outlet holes of the cylinder so that lower portion of the wings are approached to each other with a predetermined angle.

14. The 4-wheel drive of a hydraulic manual and automatic transmission according to claim 13, wherein a space (A) is formed in an upper portion of the cylinder toward the outlet hole so that liquid is not pressed by the wing.

15. A 4-wheel drive of a hydraulic manual and automatic transmission, which drives a brake device by operating a master cylinder by means of a brake pedal the 4-wheel drive comprising: a hydraulic pressing device connected to the master cylinder in parallel so as to supply hydraulic pressure to drive the master cylinder; and an electronic control device for sensing an engine speed, a stop state, an engine start and an accelerating state of a vehicle to operate the hydraulic pressure device.

16. The 4-wheel drive of a hydraulic manual and automatic transmission according to claim 12, wherein two wings inserted to the main shaft in the cylinder are coupled to lower portions of inlet and outlet holes of the cylinder so that lower portion of the wings are approached to each other with a predetermined angle.
